(19) United States
(12) Patent Application Publication
(10) Pub. No.: US 2022/0219904 A1
(43) Pub. Date: Jul. 14, 2022

(54) TRANSPORT RACK AND TRANSPORT RACK DOCKING INTERFACE

(71) Applicant: ALERT INNOVATION INC., North Billerica, MA (US)

(72) Inventors: John G. Lert, JR., Wakefield, MA (US); William J. Fosnight, Windham, NH (US); Ben Ngo, Melrose, MA (US); Mark Solomon, Lexington, MA (US); Samuel White, Lowell, MA (US); Julian Warhurst, Portsmouth, RI (US)

(73) Assignee: ALERT INNOVATION INC., North Billerica, MA (US)

(21) Appl. No.: 17/573,910

(22) Filed: Jan. 12, 2022

Related U.S. Application Data
(60) Provisional application No. 63/136,584, filed on Jan. 12, 2021.
(60) Provisional application No. 63/250,864, filed on Sep. 30, 2021.

(51) Int. Cl. B65G 1/137; B65G 1/04; G05D 1/00; B65G 1/10

(52) U.S. Cl. CPC B65G 1/1378; B65G 1/0492; G05D 1/0055; B65G 2203/0283; B65G 1/1371; B65G 1/0485; B65G 1/10

(57) ABSTRACT

An automated storage and retrieval facility is disclosed including a storage structure, mobile robots and mobile racks for use in inventory management, order fulfillment and automation-based capacity planning. In examples, a rack or racking system may be used to transport containers, for example, totes. The rack is configured to attach to a load/unload docking station at the storage structure that enables the mobile robots to load totes onto the rack and/or unload totes from the rack. The racks can further be loaded onto a truck that transports the totes between facilities.

### CLAIM OF PRIORITY

The present application claims priority to U.S. Provisional Patent Application No. 63/136,584 filed on Jan. 12, 2021 entitled “TRANSPORT RACK AND TRANSPORT RACK DOCKING INTERFACE” and U.S. Provisional Patent Application No. 63/250,864 filed on Sep. 30, 2021 entitled “TRANSPORT RACK AND TRANSPORT RACK DOCKING INTERFACE”, which applications are incorporated by reference herein in their entirety.

### BACKGROUND

An order-fulfillment system for use in supply chains, for example in retail supply chains, may fulfill orders for individual product units, referred to herein as “eaches” (also called “pieces”, “inventory”, “items” or, generally, any articles available for purchase in retail as a purchase unit, etc.), which are typically packaged and shipped by the manufacturer in cases.

In a conventional distribution model, the retailer receives pallets of cases at a distribution center (“DC”), the essential role of which is to replenish the inventories in a network of stores by periodically shipping to each store a specific set of cases of products that are needed (have been “ordered”) by that store. In the vast majority of DCs, those orders are fulfilled using a manual case-picking process in which pallets of cases are arrayed in aisles and human operators travel from one product pallet to another to transfer from each the number of cases ordered by the store, placing the selected cases on an order pallet to be shipped to the store. In some DCs, automated case-picking systems are used, the most advanced of which use mobile robots, such as those described in U.S. Pat. No. 8,425,173. Such automated systems do not provide for bulk transport of containers within the distribution center or downstream to retail stores.

### SUMMARY

The present technology, roughly described, relates to an automated storage and retrieval facility comprising a storage structure, mobile robots and mobile racks for use in inventory management, order fulfillment and automation-based capacity planning. In embodiments, a rack or racking system may be used to transport containers, for example, totes. The rack is configured to attach to a load/unload docking station at the storage structure that enables the mobile robots (or “bots”) to load totes onto the rack and/or unload totes from the rack. The racks can further be loaded onto a truck that transports the totes between facilities.

In one example, the present technology relates to a docking station for docking a rack for transfer of containers to and from the rack by an autonomous mobile robot in a storage area, the docking station comprising: a port into which the rack may be received for transfer of containers to and from the rack; an engagement mechanism configured to move the rack into a secured position in the port; sensors for sensing when the rack is secured in the port; and a barrier configured to cover the port in the absence of a rack to separate the autonomous mobile robot in the storage area from an area adjacent the docking station where the rack travels, and to uncover the port when the rack is secured in the port to allow transfer of containers to and from the rack by the autonomous mobile robot.

In a further example, the present technology relates to a system for transferring containers to and from a storage area to fulfill inventory orders in an automated storage and retrieval facility, the system comprising: a rack configured to carry a plurality of containers and including engagement features configured to be engaged when securing the rack; and a docking station for docking the rack for transfer of the plurality of containers to and from the rack by an autonomous mobile robot in a storage area, the docking station comprising: a port into which the rack may be received for transfer of containers to and from the rack; an engagement mechanism configured to engage the engagement feature of the rack to move the rack into a secured position in the port; sensors for sensing when the rack is secured in the port; and a barrier configured to cover the port in the absence of a rack to separate the autonomous mobile robot in the storage area from an area where rack is moved to and from the port, and to uncover the port when the rack is secured to allow transfer of containers to and from the rack by the autonomous mobile robot.

In another example, the present technology relates to a system for fulfilling inventory orders using containers in an automated storage and retrieval facility, the system comprising: a storage area comprising static storage locations for storing the containers; a mobile robot configured to travel on rails adjacent the static storage locations to transfer containers to and from the static storage locations; a rack comprising multiple levels configured to carry the containers, the rack being mobile and configured to move around the automated storage and retrieval facility; and a docking station positioned at the storage area, the docking station configured to receive the rack and register the rack in a position adjacent the rails at the storage area enabling the mobile robot to transfer containers to and from the rack.

In a further embodiment, the present technology relates to a system for fulfilling inventory orders using containers in an automated storage and retrieval facility, the system comprising: a storage area comprising first and second static storage locations for storing the containers, the first and second static storage locations each comprising multiple levels for storing containers; an aisle positioned between the first and second static storage locations; a mobile robot configured to travel within the aisle to transfer containers to and from the first and second static storage locations; a rack comprising multiple levels configured to carry the containers, the rack being mobile and configured to move around the automated storage and retrieval facility; and a docking station positioned adjacent the first static storage location, on a side of the first static storage location opposite the aisle, the docking station configured to receive the rack and register the rack in a position adjacent the first static storage location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments of the present technology will be described with reference to the following figures.

FIG. 1 is a perspective view of a rack according to embodiments of the present technology

FIGS. 2A-2C are perspective views of racks loaded onto a truck or being loaded onto a truck.

FIGS. 3A-3I are perspective views of a storage structure including a docking station for receiving a rack.

FIGS. 4A-4B are perspective views of a rack according to alternative embodiments, and a storage structure including a docking station for receiving the alternative rack.

FIGS. 5A-5D show partial isometric views of a rack including tote locking detail according to embodiments of the present technology.

FIGS. 6A-6F are front, side, top and perspective views of casters for transporting racks according to embodiments of the present technology.

FIGS. 7A-7B are perspective views showing further details of a storage structure and docking station for receiving a rack according to embodiments of the present technology.

FIGS. 8A-8B are perspective views showing a docking station engaged with a rack according to embodiments of the present technology.

FIGS. 9A-9C are views of an alternative docking station including a guide rail and guide roller according to embodiments of the present technology.

FIGS. 10A-10L are views of a docking station configured to receive a rack on a first side and a mobile robot on a second side according to embodiments of the present technology.

FIGS. 11A-11B are perspective views illustrating an autonomous mobile robot for transporting a rack according to embodiments of the present technology.

FIGS. 12A-12B are edge views illustrating a rack positioned at a docking station with a mobile robot including a transfer mechanism for transferring containers between the rack and the mobile robot according to embodiments of the present technology.

FIGS. 13A-13B are edge views illustrating a rack positioned at a docking station adjacent an array of storage locations including a transfer mechanism in the rack and storage locations for transferring containers between the rack and the storage locations according to embodiments of the present technology.

FIG. 14 is a perspective view showing racks loaded onto trucks including and aisle between the racks allowing a delivery technician to remove inventory from the racks for home delivery according to embodiments of the present technology.

FIG. 15 is a perspective view of a storage area and a stand-alone decant station where containers may be loaded into a rack according to embodiments of the present technology.

FIG. 16 is a flowchart for docking and undocking with safety features of FIGS. 3A-I.

FIG. 17 is a flowchart for transporting site to site where each site has automation and storage.

FIG. 18 is a flowchart for FIGS. 12A and 12B.

FIG. 19 is a flowchart for FIG. 13A.

FIG. 20 is a flowchart for FIG. 13B.

FIG. 21 is a flowchart for using the truck in FIG. 14 to deliver grocery orders to customers.

FIG. 22 is a flowchart for decant like FIG. 15.

FIG. 23 is a flowchart for replenishing the automation using a rack and pulling inventory from the store floor.

### DETAILED DESCRIPTION

Embodiments of the present technology will be described with reference to the figures, which in general relate to a rack or racking system for use in inventory management, order fulfillment and automation-based capacity planning. More specifically, the technology relates to a rack or racking system used to transport containers, for example, totes, which can attach to a load/unload docking station or fixture that enables bots to load totes onto the rack and/or unload totes from the rack, and further can be loaded onto a truck that transports the totes between facilities.

It is understood that the present embodiments may be embodied in many different forms and should not be construed as being limited to the embodiments set forth herein. Rather, these embodiments are provided so that this disclosure will be thorough and complete and will fully convey the invention to those skilled in the art. Indeed, the embodiments are intended to cover alternatives, modifications and equivalents of these embodiments, which are included within the scope and spirit of the invention as defined by the appended claims. Furthermore, in the following detailed description, specific details are set forth in order to provide an understanding of the present embodiments.

The terms “top” and “bottom,” “upper” and “lower” and “vertical” and “horizontal” as may be used herein are by way of example and illustrative purposes only and are not meant to limit the description of the embodiments inasmuch as the referenced item can be exchanged in position and orientation. Also, as used herein, the terms “substantially” and/or “about” mean that the specified dimension or parameter may be varied within an acceptable manufacturing tolerance for a given application. In one non-limiting embodiment, the acceptable manufacturing tolerance may be ±0.25%, for example, +/−3 mm tolerance in the Z (vertical) and +/− more in the X down aisle.

The racking systems disclosed may be used in conjunction with a robotic picking system(s) and robotics, for example, as disclosed in U.S. Patent Publication Number US2017/0313514 A1 having publication date Nov. 2, 2017 and entitled “Order Fulfillment System” which is incorporated by reference herein in its entirety. Similarly, the racking systems disclosed may be used in conjunction with a robotic picking system(s) and robotics that are deployed in conjunction with retail store formats, for example, as disclosed in U.S. Patent Publication Number US2018/0134492 A1 having publication date May 17, 2018 and entitled “Automated-Service Retail System and Method” which is incorporated by reference herein in its entirety. Further, the racking systems disclosed herein may be used in conjunction with different elements of full or partially automated supply chain systems, for example, as disclosed in the following: U.S. Patent Publication Number US2018/0150793 A1 having publication date May 31, 2018 and entitled “Automated Retail Supply Chain and Inventory Management System”; U.S. Patent Publication Number US2018/0194556 A1 having publication date Jul. 12, 2018 and entitled “Interchangeable Automated Mobile Robots with a Plurality of Operating Modes Configuring a Plurality of Different Robot Task capabilities”; U.S. Patent Publication Number US2018/0247257 A1 having publication date Aug. 30, 2018 and entitled “Inventory Management System and Method” and U.S. Patent Publication Number US2018/0341908 A1 having publication date Nov. 29, 2018 and entitled “Fully Automated Self Service Store”, all of which are incorporated by reference herein in their entirety. Further, the racking systems disclosed herein may be used in conjunction with different elements of racking systems, for example as disclosed in U.S. Patent Application No. 63/013,504 entitled Transport Rack Cartridge (TRC) having a filing date Apr. 21, 2020 and U.S. Patent Publication Number US2018/0194556 A1 having publication date Jul. 12, 2018 and entitled “Interchangeable Automated Mobile Robots with a Plurality of Operating Modes Configuring a Plurality of Different Robot Task capabilities” all of which are incorporated by reference herein in their entirety.

The racking systems disclosed may be utilized in the foregoing examples and further by way of non-limiting example in applications such as summarized in Table 1:

TABLE 1

| CLASSIFICATION | IN | OUT |
|---|---|---|
| DC (Distribution | Pallets | Rainbow Pallets |
| Center) | | |
| RDC (Regional | Pallets, Rainbow | Single & Mixed SKU |
| Distribution Center) | Pallets, Empty Totes | Product Totes |
| Darkstore | Single & Mixed SKU | Order Totes, Empty |
| | Product Totes, Empty | Totes |
| | Totes | |
| RSD (Remote Storage | Order Totes | Empty Totes |
| Dispense) | | |
| SPSD (Store Picking & | Single & Mixed SKU | Order Totes, Empty |
| Storage Dispense) | Product Totes, Empty | Totes |
| | Order Totes | |
| SSD (Store Storage | Closed System | Closed System |
| and Dispense) | | |

A classification example that may utilize the racking systems disclosed herein may be a retail or other Distribution Center (DC). A Distribution Center (DC) may distribute goods to retail stores or Regional Distribution Centers (RDC) where the distribution center may be one or more warehouse(s) that receives pallets that may contain common cases of goods and ships “rainbow pallets” that may contain layers or mixed cases of goods for shipment to Regional Distribution Centers. The disclosed rack system may be utilized to store and ship the goods from multiple pallets or in the absence of pallets may be utilized to store and ship racks of cases, or totes containing the contents transferred from the cases.

Another classification example that may utilize the racking systems disclosed herein may be a Regional Distribution Centers (RDC) that distributes goods to retail stores. Here, the regional distribution center may be one or more warehouse(s) that receives pallets of common cases, rainbow pallets of mixed cases, and/or empty totes and ships single & mixed SKU Product Totes to retail stores.

Another classification example that may utilize the racking systems disclosed herein may be a Darkstore that distributes goods to customers. Here, the Darkstore may be one or more warehouse(s) that receives Single & Mixed SKU Product Totes or Empty Product totes and ships or dispenses Order Totes to customers or Empty Order Totes to be replenished.

Another classification example that may utilize the racking systems disclosed herein may be a Remote Storage Dispense facility (RSD) that distributes goods to customers. An RSD facility may be used primarily where the facility uses totes primarily for storage and dispense only. Here, the Remote Storage Dispense may be one or more location(s) that receives Order Totes and ships or dispenses Orders customers or Empty Totes to be replenished.

Another classification example that may utilize the racking systems disclosed herein may be a Store Picking & Storage Dispense facility (SPSD) that distributes goods to customers. Here, the Store Picking & Storage Dispense facility may be one or more location(s) that receives Single & Mixed SKU Product Totes or Empty Order Totes and ships or dispenses Order Totes to customers or Empty Totes to be replenished.

Another classification example that may utilize the racking systems disclosed herein may be a Store Storage and Dispense facility (SSD). Although this type of facility is a closed system, the racking system may be utilized, for example, for importing additional order totes remotely as supplemental to floor picking with order or product totes being received and empty totes shipped to be replenished.

Each of the exemplary instances above are provided as an array of possible applications of the racking systems disclosed herein where numerous applications may be anticipated. For example, the racking system described may be used in ambient picking systems for shipping, receiving and replenishment. Similarly. The racking systems described may be used with ambient picking systems but also with chilled or frozen picking systems. Accordingly, and by way of example, anything within or downstream of a distribution center may utilize the racking systems disclosed to manage inventory for industrial or commercial product or merchandise with cases, totes, sub-totes or otherwise within a given supply chain or operation. Another example is where general merchandise orders might be shipped on tracks to a store to be integrated with customers' grocery orders.

Much of the labor requirements to operate a picking system stems from the need to pull van delivery orders, place them in a rack and load them onto the truck. The disclosed racking system is provided to reduce the amount of labor required to do this task and improve the overall system efficiency.

Racks may be used to efficiently transport totes between storage and picking systems located in different locations. As will be described, racks dock directly with storage structures where bots can directly pick and place totes from and to the rack. By way of example, a rack docked to a storage structure may be filled with totes containing customer orders. Once all shelves of the rack have been populated with totes, the rack may be undocked from the storage system and transported either manually, or by autonomous mobile robot (AMR) into a transport truck, for example, a 13′ commercial box truck. The box truck transports the rack to a RSD where it is manually unloaded by associates. The order totes will either be inducted into the system or manually delivered to customers. If inducted, the order totes will be transported to customer portals via bots, where customers retrieve their orders. Then, the bots retrieve the now empty totes and place them back into the rack. Once a rack contains all empty totes, it is undocked from the RSD and transported either manually or with an AMR back to the box truck for transport back to an Automated Picking, Storage & Dispense (APSD) system. This closed loop operation enables efficient and fully automated transport of totes between facilities where measures for human safety are considered and described. Efficiency may further be gained by how the bots load and unload the rack with each cycle. Initially, one tote is removed from the rack to create a vacancy. After this cycle, each bot loads one tote into the rack at the vacant position, and retrieves an adjacent tote, thereby creating a vacancy for the subsequent bot cycle.

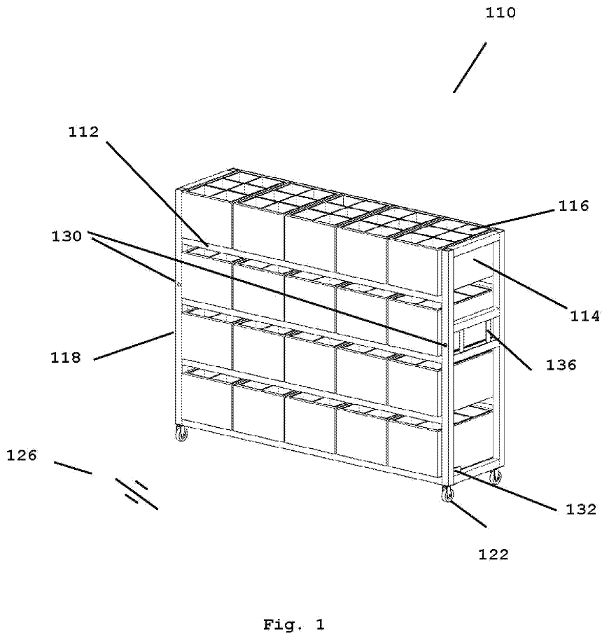

Referring now to FIG. 1, there is shown an isometric view of rack 110. Rack 110 has tote support structure 112 holding totes 114 where totes 114 may also have sub-totes 116 for carrying goods. Tote support structures may also be referred to as “shelf structures” or “shelf modules” or otherwise as alternatives to “tote supports”. Rack 110 is shown with 5 totes 114 in each row of totes; in alternate aspects more or less totes may be provided. Vertical supports 118 may be provided in rack 110 supporting four rows of totes each respectively. In the embodiment shown, four rows each are shown but in alternate aspects, more or less rows may be provided. For example, racks used for picking goods from the store floor may be 3 rows high to permit workers to see above the racks. Casters 122 may be provided to support rack 110 and allow rack 110 to be freely moved around on a surface 126, for example on a surface that allows rack 110 to be coupled to a structure that allows Bots to access racks 110 or on a surface that may be a loading dock for trucks, containers or otherwise. As a further alternative, casters 122 may allow free movement on a surface that is in the interior of a truck box or container where rack 110 may be restrained to the interior of the truck box or container for transport or shipment to another facility, for example, retail facility, distribution center or otherwise as described. Casters 122 may be conventional rotating and locking casters or simply conventional casters; in alternate aspects, casters 122 may be spherical wheels to make the heavy rack easier to maneuver into position.

Rack 110 may have guide features 130, for example holes in the rack structure that correspond to mating pins in the mating automation where the holes may provide location and a go/no-go feature with respect to the mating pins. Here, docking features are provided that secure the rack to the storage structure when docked as will be described. Rack 110 may have interlock or identification features such as feature 132 on one side or two opposed or adjacent sides of rack 110. Feature 132 may be a RFID tag or other identification feature or location indicia that may be provided to detect identification of the rack and or location of the rack with respect to a mating interface such that the rack may be determined to be in position, for example, to allow totes to be removed from or inserted into the rack 110 by Bots. Here RFID or other suitable tags 132 may provide for safety interlocking of the rack 110 with respect to mating or docking structure. Handles 136 may be provided to allow an operator to ergonomically move rack 110 from location to location. Although rack 110 may have any suitable size, representative dimensions may have totes at 415 mm horizontal tote pitch and 400 mm vertical tote pitch with 167 mm from the floor surface to the bottom of level 1 of the totes. The overall size of the rack may have a width of 2190 mm or 86.22″ that fits within a 88.25″ box truck door width as will be shown; a height of 1667 mm or 65.63″ fits within a 71.25″ box truck door height as will be shown; and 590 mm depth where 600 mm totes may protrude 22 mm and with a 12 mm maximum rear panel dimension. Alternately, any suitable dimension may be used, for example, tote guides overhang of 1.6 inches. Although racks 110 will be shown inserted depth-wise into the box of a truck, racks 110 may be oriented in any suitable arrangement within the box of a truck, shipping container or otherwise.

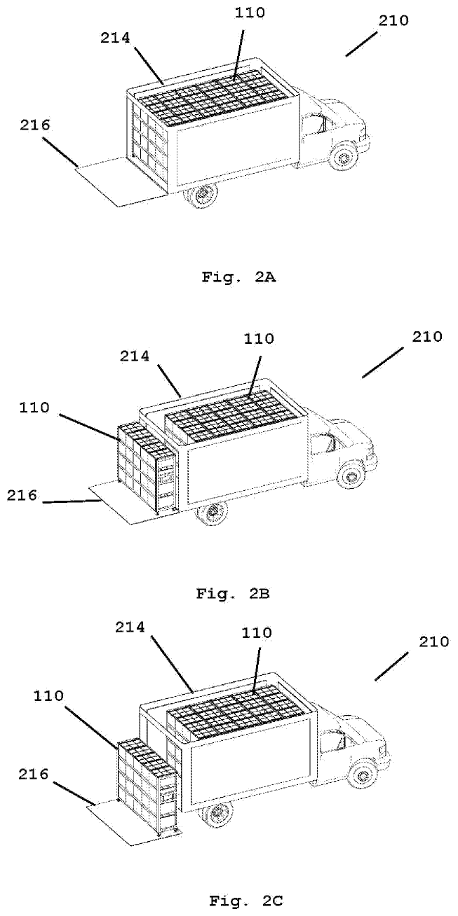

Referring now to FIGS. 2A-2C, there is shown isometric view of truck 210. Truck 210 is shown having box 214 and liftgate 216. In FIG. 2A, truck 210 is shown as a 13′ Box truck fully loaded with racks 110. In alternate aspects a different sized truck loaded with more or less racks in alternate orientations may be provided. By way of example, truck 210 is shown with 6 racks 110 each 5 totes wide and 4 totes high for a total of 120 totes in truck 210 when loaded. Truck 110 may be provided with features not shown, for example, environmental control features such as heating or cooling features and docking features that allow racks 110 to be secured within box 214. In FIG. 2B, truck 210 is shown with one of the racks 110 withdrawn from box 214 onto liftgate 216 which is shown in an up position. Here, rack 110 is shown on liftgate 216 where liftgate 216 may have for example an 1800 lb. capacity with rack 110 having less than a 1200 lb. load. In FIG. 2C, truck 210 is shown with one of the racks 110 withdrawn from box 214 onto liftgate 216 which is shown in a down position where rack 110 may be removed from the truck 210.

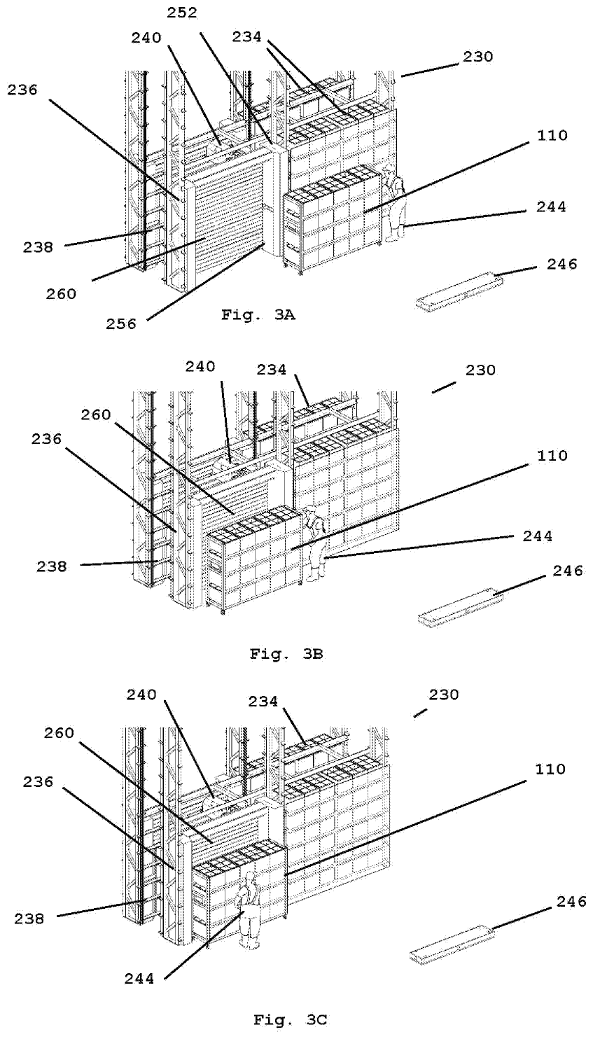

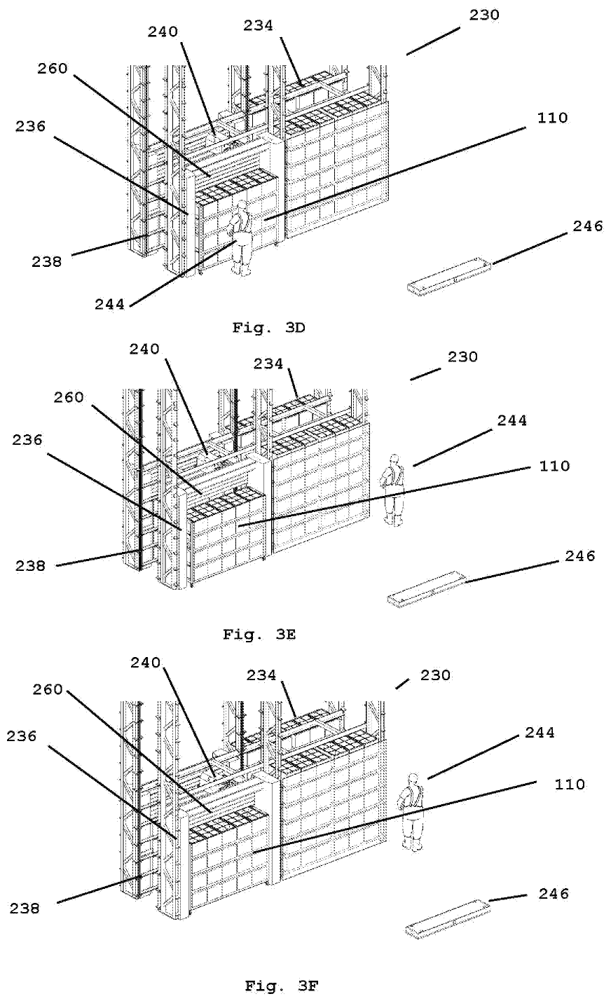

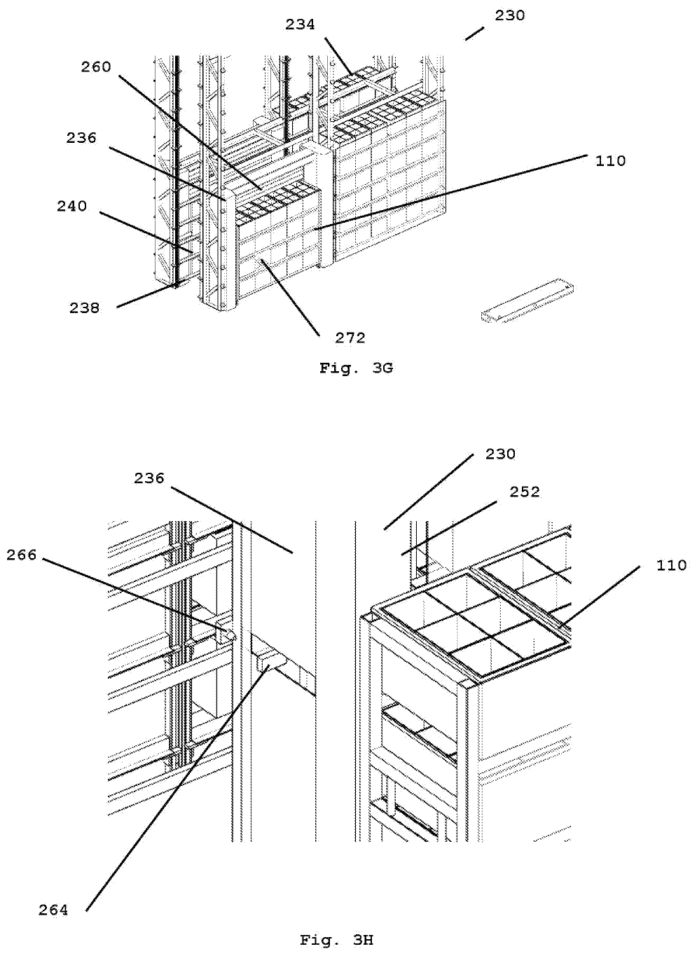

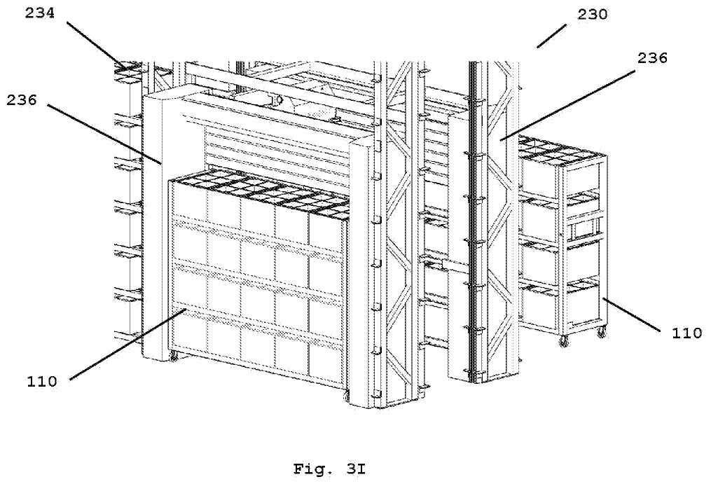

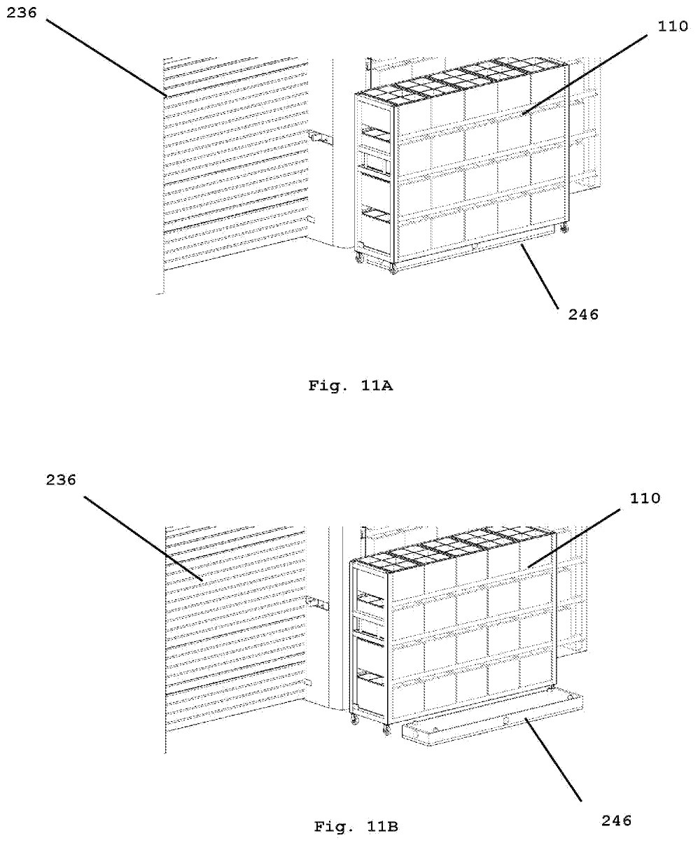

Referring now to FIGS. 3A-3I, there are shown isometric views of storage structure 230. Storage structure 230 has static storage locations 234, rack docking station 236 and bot support rails 238 that are provided to support autonomous bot 240 such that autonomous bot 240 may access any tote for removal or placement with respect to static storage locations 234 and rack 110 when docked. Operator 244 is shown moving rack 110 into the docking station 236. As can be seen in FIGS. 11A and 11B, in alternate aspects, autonomous mobile robot (AMR) 246 may be provided to move rack 110 from location to location. Rack 110 may have a bottom plate used for lifting, or propelling on its casters by the AMR where the bottom plate may have locking features to secure rack 110 to the AMR and where the bottom plate may further be used as ballast to prevent tipping of rack 110 during transport or movement. Alternately, extensions (wheelie bars) may extend from the rack and nest as shown with respect to the casters. As seen in FIGS. 3A and 3H, docking station 236 has housing 252 which is shown with lead in edges for guiding rack 110 into docking station 236. Further docking station 236 has RFID Safety Reader(s) 256 that correspond to safety and/or id tags on rack 110. Further docking station 236 has safety door 260 (may be a roll up door or other suitable door) that prevents the operator from being able to access the safety zone in which bot 240 is operating. Here, door 260 provides a safety features to prevent human contact with exposed bot traffic within structure 230. The safety door may also cooperate with the mechanism that engages rack with the docking station where the safety door may be used to seat totes that have slid out during transport with the rack being drawn toward the docking station such that the totes are driven into the rack as the rack is drawn toward the door. The rack may then be pushed away from the docking station to provide clearance between the totes in the racks allowing the door to open such that the rack can then be fully engaged with the docking station. Here, the door may be used to reseat totes into the rack prior to docking and presenting to the bots. As an alternative to the door, a safety rated light curtain may be provided that prevents humans from accessing the bots moving within the rails. When the rack is inserted sufficient to satisfy the RFID safety sensors 256, the light curtain can be disabled to allow the rack to be fully inserted into the position where bots pick and place totes. In the event a human interrupts the light curtain without the rack in place, an emergency-stop is activated to prevent the motion of all bots within the system or local to the docking module. An example of a suitable safety system in which safety door 260 may be utilized to prevent operator injury is disclosed in U.S. Patent Publication No. US2019/0176323 entitled “Configurable Service Isolation Zone for Service of Equipment Employing mobile Robots” published Jun. 13, 2019 and incorporated by reference herein in its entirety.

Further docking station 236 has side latches 264 and pins 266 where side latches 264 (both sides) need to be engaged by the rack 110 in order to safely allow the safety door 260 to open safely and where side latches 264 further pull the rack 110 into engagement with pins 266 where the pins 266 (both sides) need to mate with corresponding holes in rack 110 before bot 240 can reliably access the totes in rack 110. The pin hole interface may serve as an interlock that ensures the rack is adequately positioned to promote reliable transfers of the totes by the bots. Here, side latches 264 lock the rack in place when connected to the storage structure. RFID safety readers 256 or other sensing of rack 110 may be provided to serve as verification that rack 110 is in position, for example to allow door 260 to safely open. FIG. 3A shows rack 110 during loading with rack 110 being transported by operator 244 and with the safety door 260 closed. FIG. 3B shows rack 110 during loading with rack 110 being transported by operator 244 with rack 110 engaging the lead in of frame 252 of docking station 236 and with the safety door 260 closed. FIG. 3C shows rack 110 during loading with rack 110 being inserted by operator 244 with rack 110 being inserted into docking station 236 and with the safety door 260 closed. Here, the safety RFID is not activated if rack 110 is not fully inserted into docking station 236 where door 260 has an additional purpose to ensure totes that may have slipped or slid out of rack 110 are fully seated in rack 110 before opening door 260. In addition to the door serving to ensure totes are fully seated in the rack, through-beam sensors or cameras may be used to identify totes protruding from the rack. In the event totes are protruding, the docking mechanism may advance the rack against the door while still closed to reseat the totes. Once the rack has been advanced to reseat the totes, the rack may be reversed to a position to where sensors may optionally confirm the totes are seated within the rack prior to opening the door and advancing the rack into its fully docked positions where bots pick the totes. FIG. 3D shows rack 110 inserted into docking station 236 with the safety door 260 safely opening. FIGS. 3E and 3F show rack 110 fully docked and locked in docking station 236 where the side latches 264 pull rack 110 onto the Go/No-Go pins 266 and where rack 110 is now fully docked, locked and accessible by bots 240. FIG. 3G shows rack 110 fully docked and locked in docking station 236 where bot 240 can now unload tote 272. FIG. 3I shows an opposing side of structure 230 where an additional docking station 236 may oppose the station as described where bot 240 can access totes on either side of structure 230.

In embodiments including an upwardly opening door 260, the door may open to its fullest extent when the sensors confirm the rack is in its fully docked position. Alternatively, the door may raise upward to height just above the height of the rack 110. Additional sensors may be provided to sense the height of the rack 110, or this information may be read from feature 132. As seen for example in FIG. 3I, a pair of docking stations 236 may be provided facing each other on opposite sides of an aisle in which BOTs 240 travel. The docking stations 236 need not be provided in opposed pairs in further embodiments.

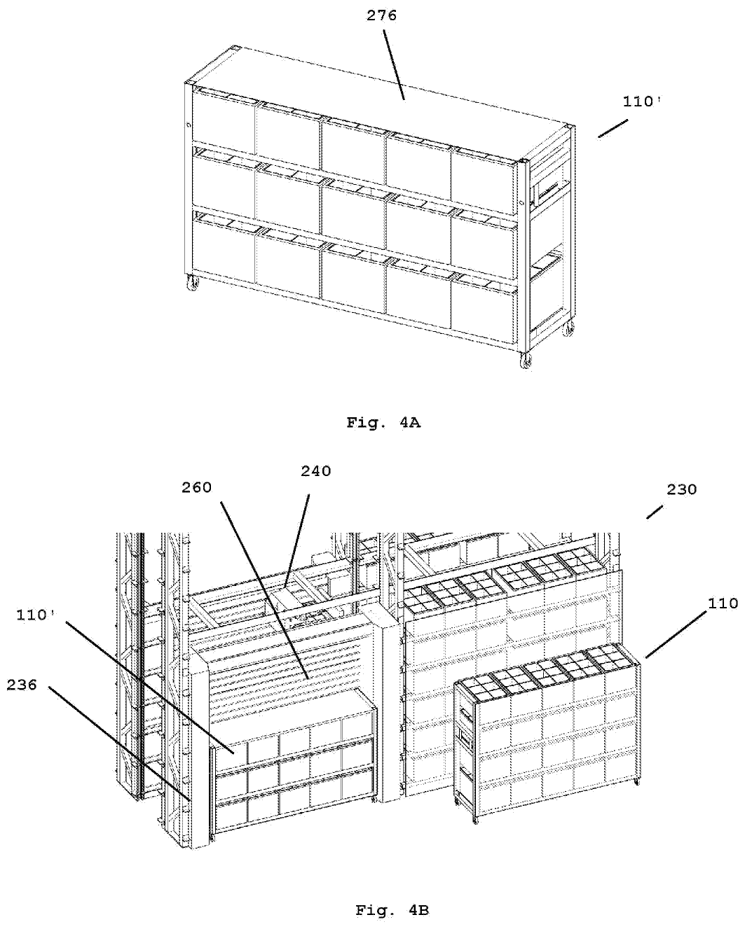

Referring now to FIG. 4A there is shown an isometric view of rack 110′. Rack 110′ may have features similar to rack 110 except rack 110′ has 3 rows of totes instead of 4 rows of totes as shown with rack 110. Further rack 110′ has cover 276 which prevents contaminants or debris from falling into the totes stored within rack 110′, for example during transport and prevents humans from accessing the top-level totes when interacting with the bots. Referring also to FIG. 4B, there is shown structure 230 where rack 110′ is docked to docking station 236. Of note is where the RFID may be a unique identifier for each rack and may track features of each rack, for example, the number of shelves in each rack such that door 260 is only opened sufficiently to allow bot 240 to safely access the shelves of rack 110′ but not opening so far as needed for access to the 4th shelf of rack 110 exposing a safety hazard. Similarly a back (not shown) may enclose the exposed side of the rack to prevent humans from reaching into the space while bots pick and place totes. Here, docking station 236 is shown able to access racks of multiple heights without reconfiguring the hardware.

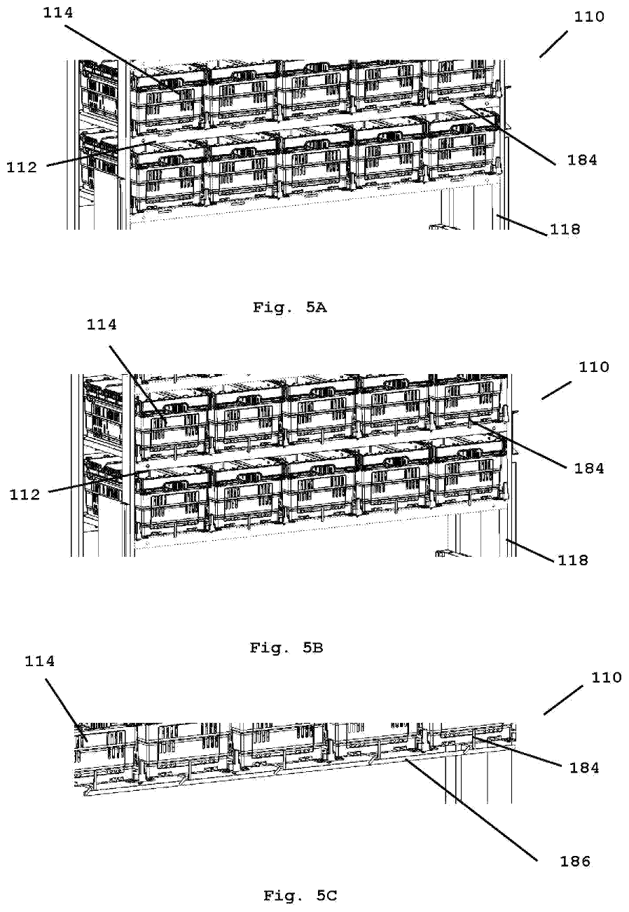

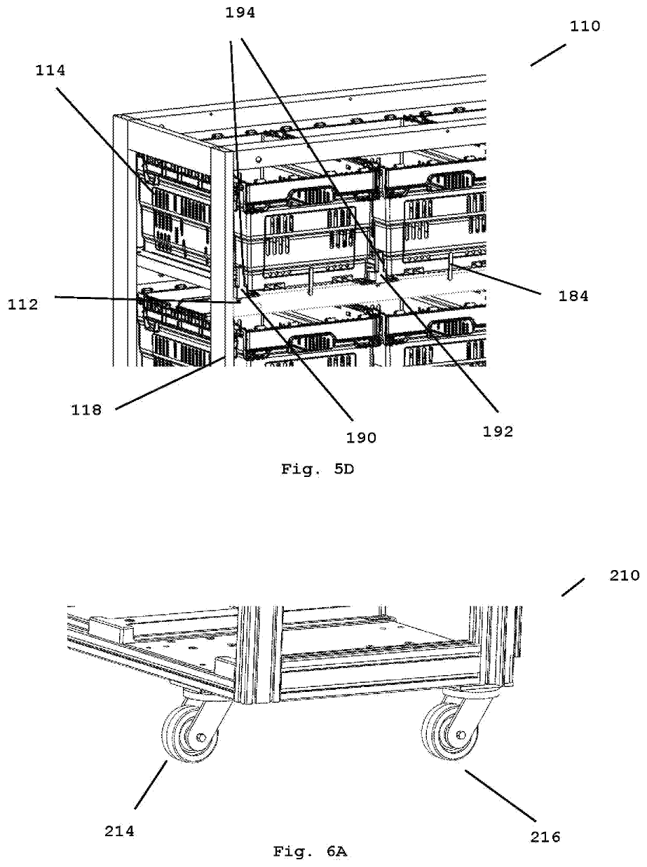

Referring now to FIGS. 5A-5D, there are shown partial isometric views of rack 110 showing tote locking detail. Totes 114 are shown nested on shelves 112 where shelves 112 are shown having a rotating retention feature 184. Each tote 114 has an individual retainer 184 that is rotated out of place as seen in FIG. 5A when the rack 110 is docked allowing the totes to be freely removed and replaced by bots or otherwise. Similarly, individual retainer 184 that is rotated in place as seen in FIG. 5B when the rack 110 is un-docked retaining the totes and preventing the totes from being removed during rack 110 transport or otherwise. FIG. 5C shows linkage 186 that engages or disengages the individual retainers 184 with respect to the totes in unison as the rack 110 is being undocked or docked. FIG. 5D shows the retainers engaged preventing the totes from being removed from rack 110. Rack 110 is also shown having features 190, 192 (tote guides) that guide totes into the rack and secure their position during transport. Features 190, 192 are shown having flags 194 that may be white or any suitable fine positioning flags. Here, cams or caroming surfaces/features may be activated to push tote locks up so the totes are retained during transit where stops may be provided on the rear of the tote guides to prevent removal at any time. In an example embodiment, totes are retained into their rack position by solely detent bumps on the horizontal surfaces of the tote guides.

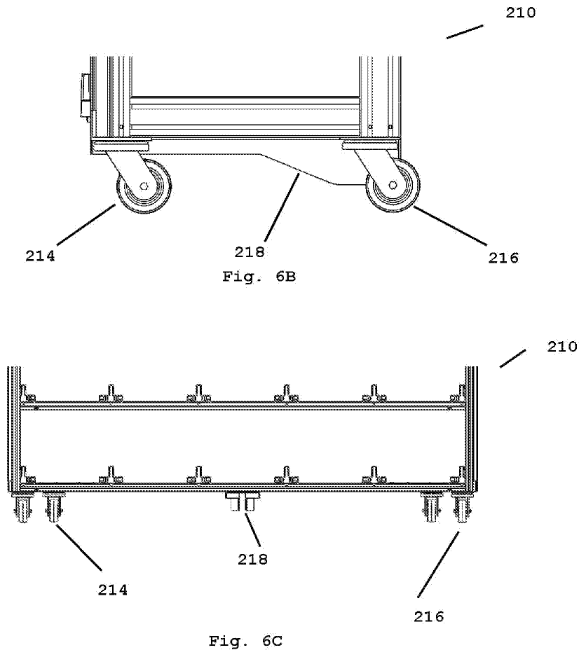

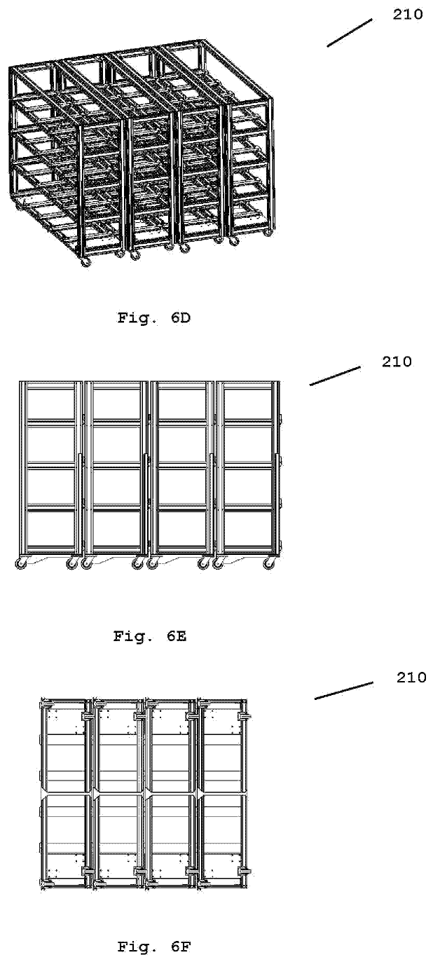

Referring now to FIGS. 6A-6C there are shown partial isometric side and rear views of rack 210. Rack 210 has front 214 and rear 216 casters that are offset such that as racks are butted together, the casters envelopes can nest within each other as seen in FIGS. 6D-6F. Here, the distance between the front casters is smaller than the distance between the rear casters such that they can engage separate ramps when docking as will be described (and/or may be utilized for nesting purposes). Guide 218 is shown as an exemplary guide that allows a stationary pin to be provided, for example, on a docking station to ensure the rack is properly positioned.

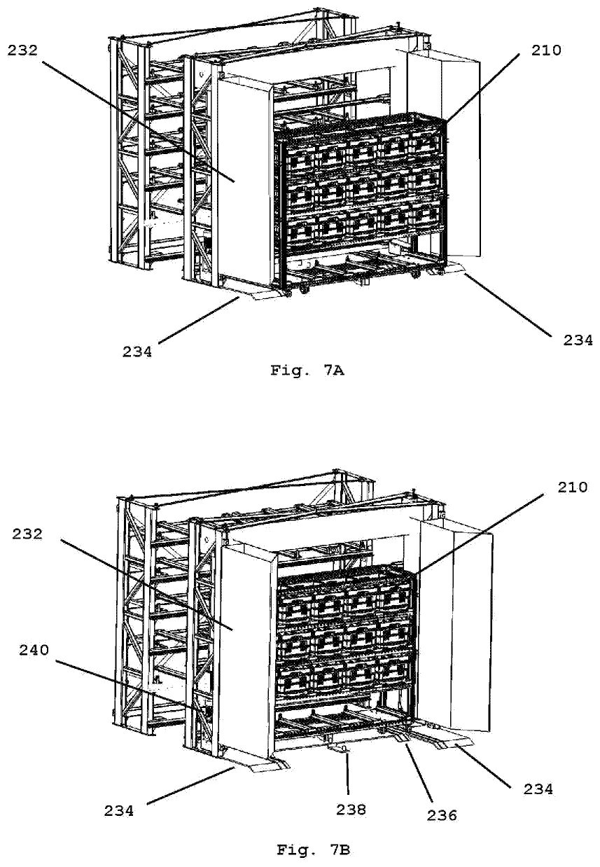

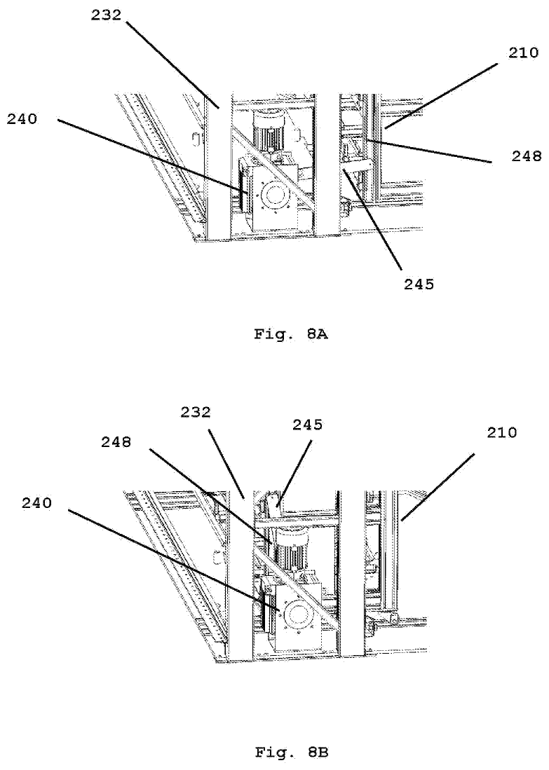

Referring now to FIGS. 7A-7B, there are shown isometric views of rack 210 and docking station 232. Docking station 232 has outer ramps 234 that engage with rear casters 216 and inner ramps 236 that engage with casters 214 such that as the rack 210 is docked the ramps cooperate with the casters such that the attitude of the rack remains horizontal as the rack is lifted from the floor. Ramps are utilized in the event the floor is uneven or to compensate for differing floor heights. Pin 238 may be provided to guide rack 210 in position and docking engagement drives may be provided to dock rack 210 to docking station 232. Referring also to FIGS. 8A and 8B there are shown partial isometric views of docking station 232 docking rack 210. Docking station 232 has docking drive 240 having rotating drive arms 245 on opposing sides of rack 210 that have rollers that engage slots 248 of rack 210 on opposing ends of rack 210. As rack 210 is moved into a docking position with docking station 232, arms 245 are lowered to allow rack 210 to clear arms 245. To dock, arms 245 rotate up as seen in FIG. 8A engaging slots 248. Arms 245 continue to rotate as seen in FIG. 8B pulling rack 210 up on the ramps and docking rack 210. In alternate aspects, any suitable docking mechanism may be provided.

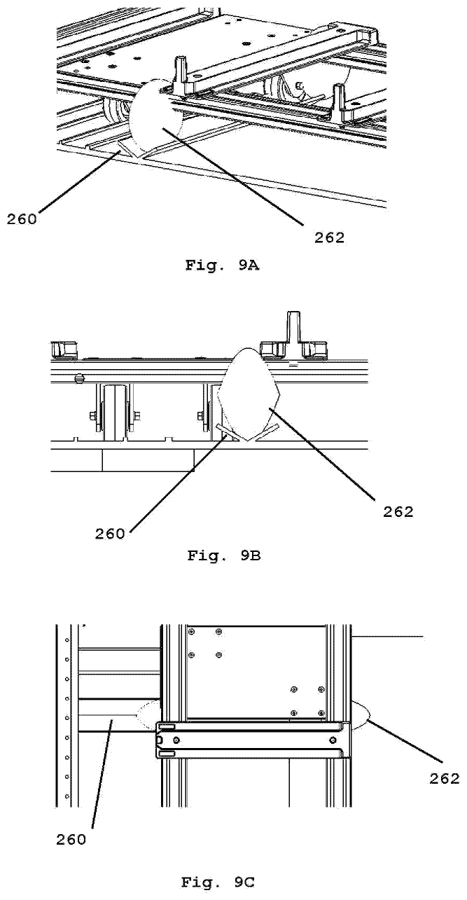

Referring now to FIGS. 9A-9C, as an alternative to guide 218 and pin 238, a guide rail 260 and guide roller 262 may be provided with docking station and rack respectively. Guide roller 262 is not in communication with the floor of the facility when the rack is being transported, thereby eliminating the effect of transportation wear on the docking accuracy of the rack to the docking station. In alternate aspects, any suitable guiding mechanism may be provided such that when the rack is docked, it is in position to allow reliable tote transfer.

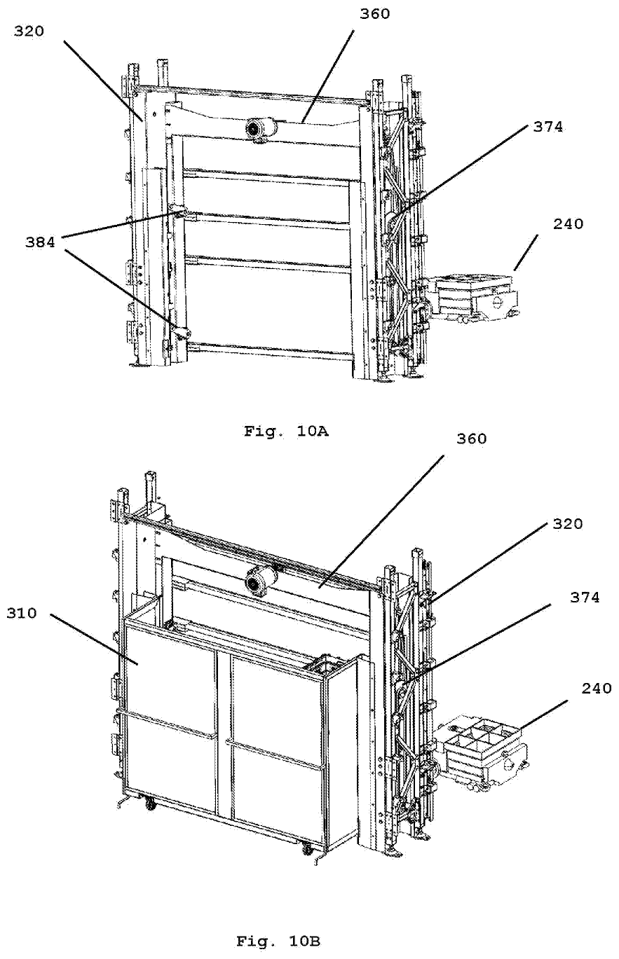

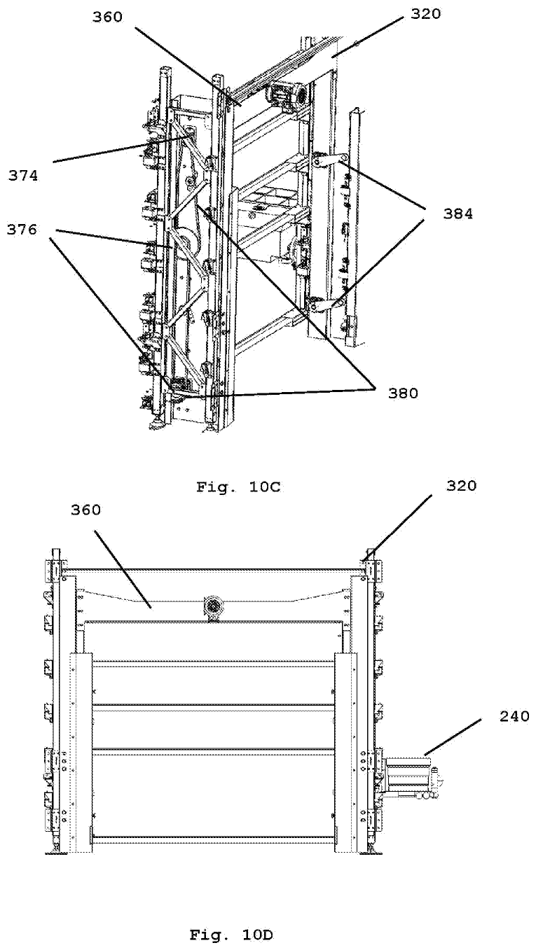

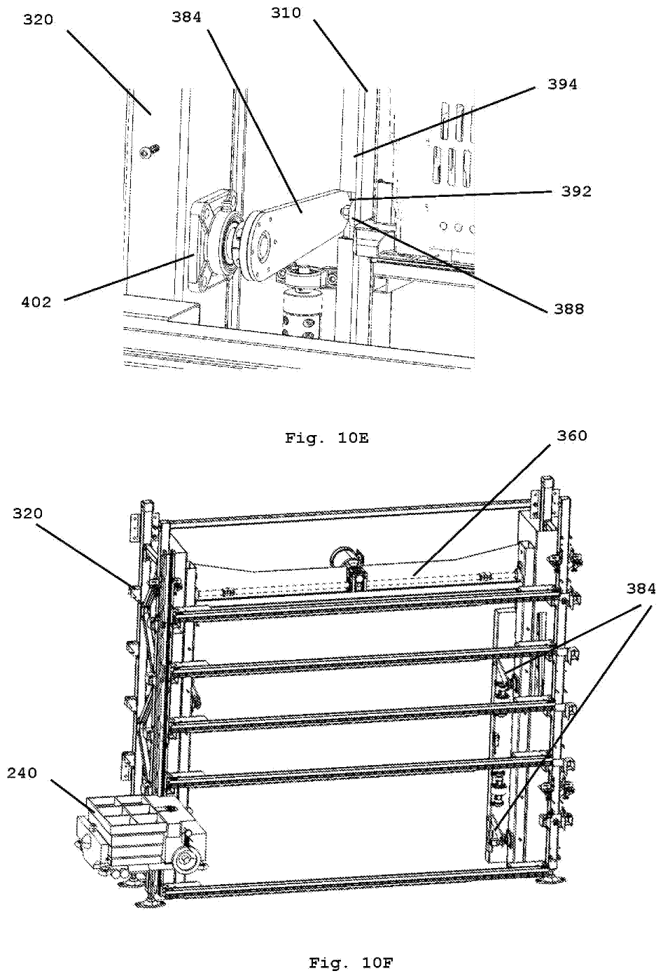

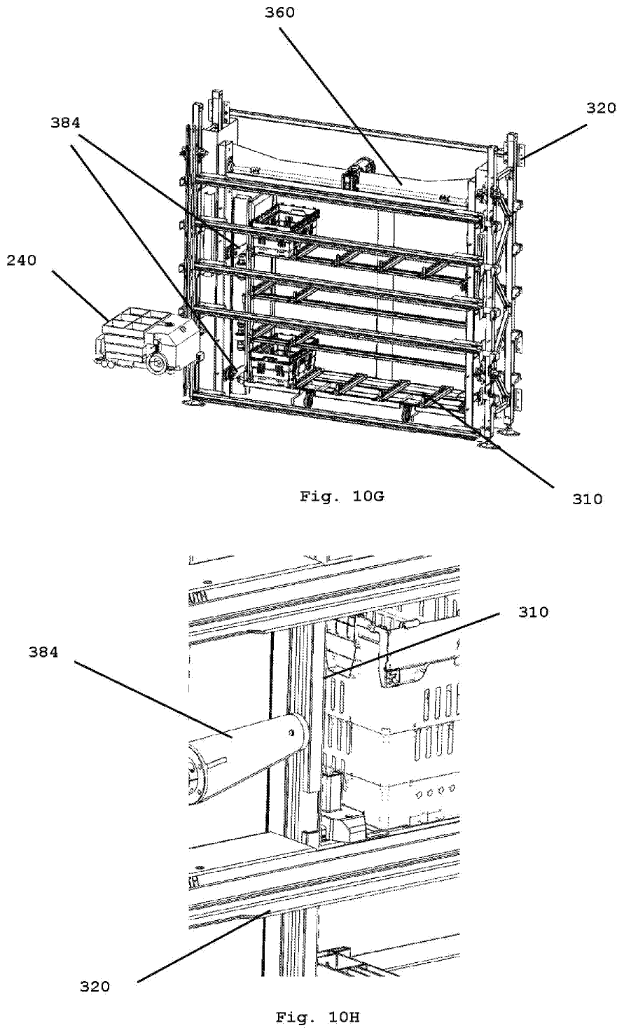

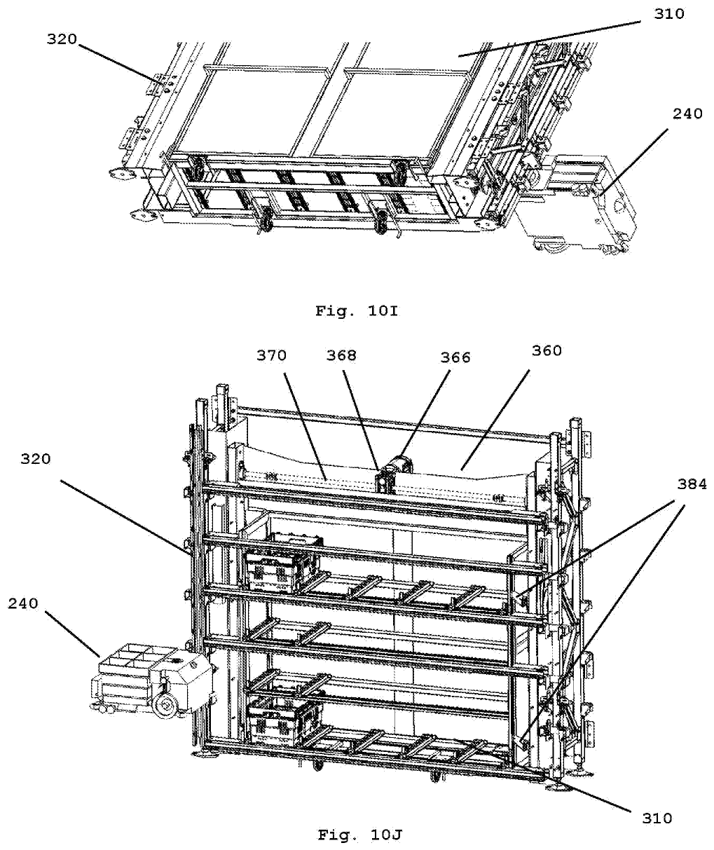

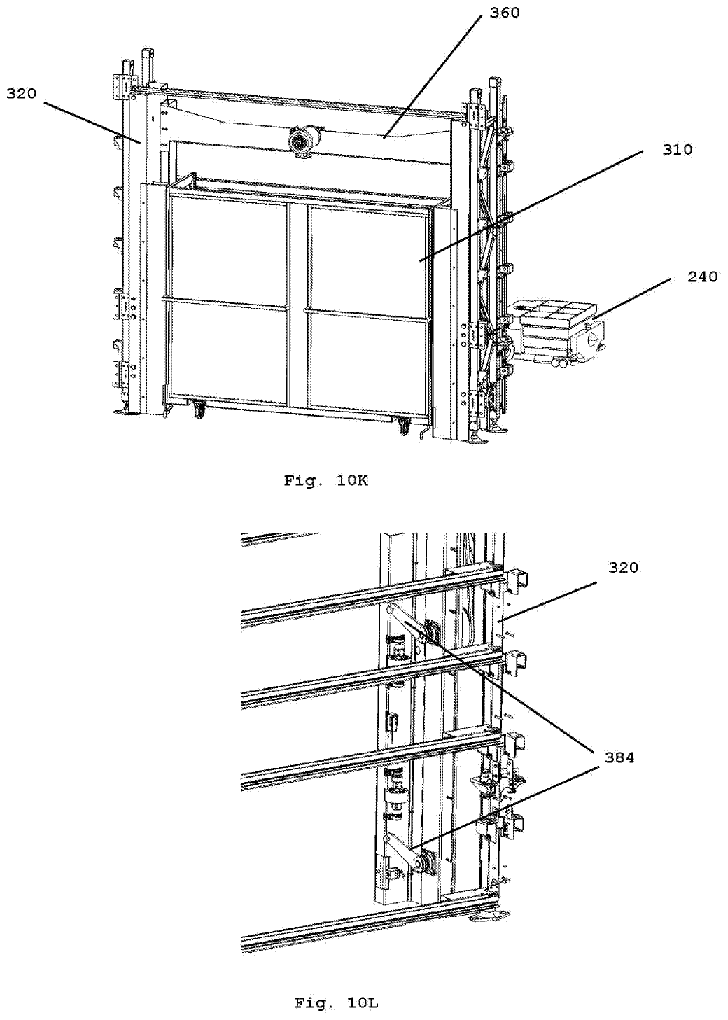

Referring now to FIGS. 10A-10L, there is shown docking station 320, rack 310 and Bot 240. In the figures, the storage structure is not shown where Bot 240 is supported on rails where rails (vertically or opposing for example) are also not shown for clarity. Further features, such as the safety door are not shown for clarity. Docking station 320 is shown illustrating an alternate docking drive mechanism 360. Docking mechanism 360 has drive motor 366 which is coupled to right angle gear or drive box 368 the output of which rotates shaft 370. As seen in FIG. 10J, shaft 370 extends to opposing sides of the docking station to drive arms 384 that engage features of the rack to dock and undock the rack as will be described in greater detail. On each side of the docking station, shaft 370 is coupled to sprockets or timing pulleys 374 which drive sprocket or timing pulleys 376 via chains or timing belts 380. Sprocket or timing pulleys 376 are coupled to rotating arms 384 which are utilized to dock and undock rack 310. Each arm 384 has a roller 388 that engages a slot 392 of opposing u-channels 394 of rack 310 where the rack 310 can engage and disengage the docking station freely as shown in FIG. 10E where the roller moves through the slot 392 in u channel 394. When the rack 310 is positioned such that the roller 388 passes through the slot 392 as shown in FIG. 10E, the rack is positioned to be engaged where rotation of the arm 384 causes the roller to pass from the slot into the u channel drawing the rack 310 into locking engagement with the docking station 320. In the exemplary embodiment, bearings 402 may be provided to constrain components such as shafts, sprockets and rotating arms. Further, limit switches and or position sensors may be provided to detect proper positioning of the rack and associated engagement features. In the manner described, rotation of drive motor 366 rotates arms 384 in unison to draw rack 310 into or out of engagement with docking station 320 as a function of rotation direction and position. In the disclosed, 4 arms are provided; 2 on each side of the rack 310; in alternate aspects more or less may be provided, for example 2 on one side and 1 on the other.

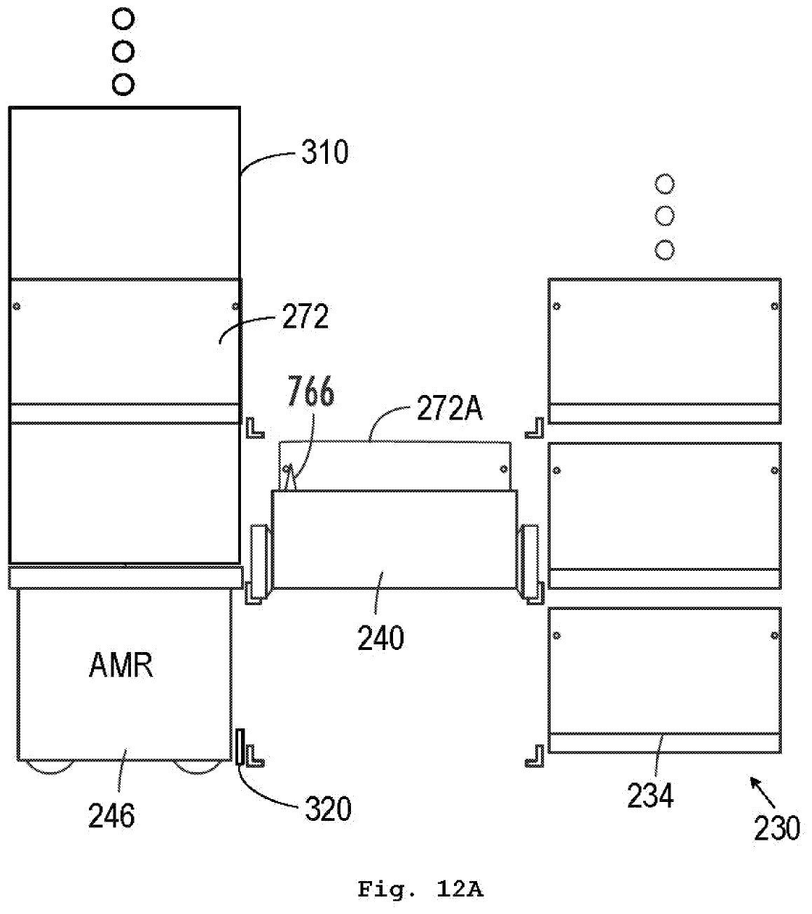

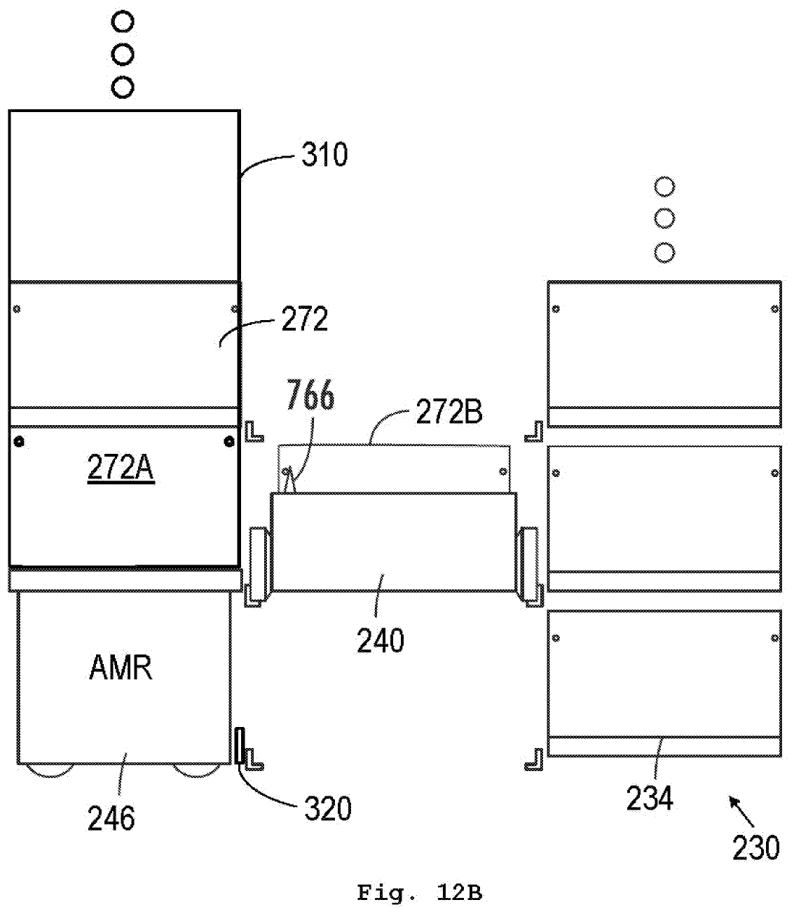

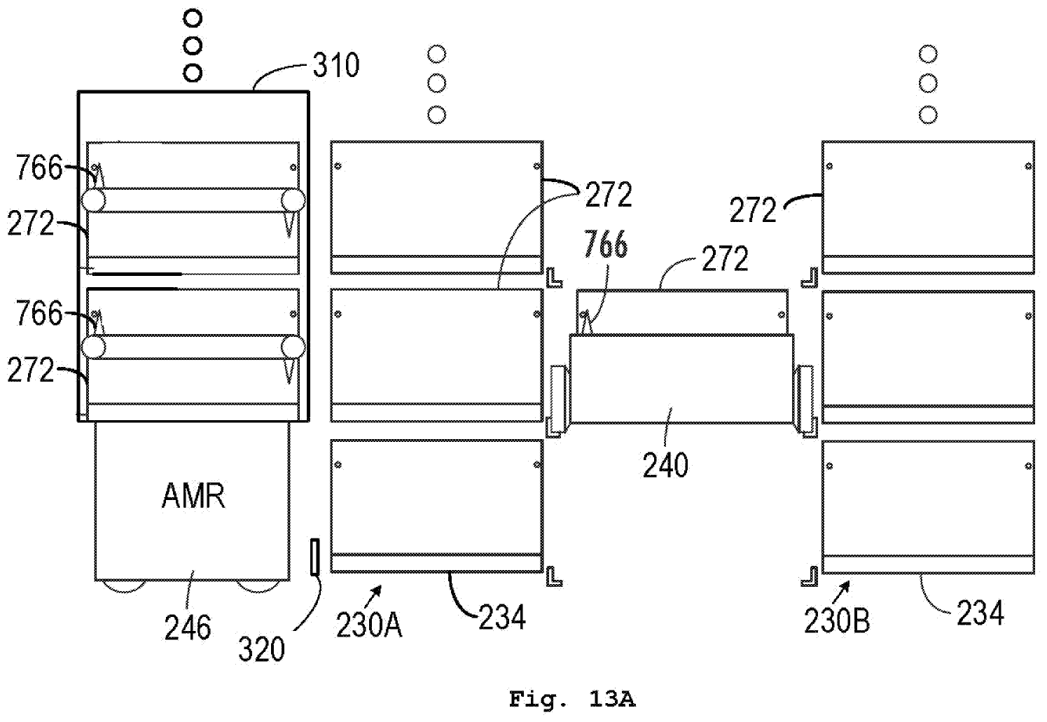

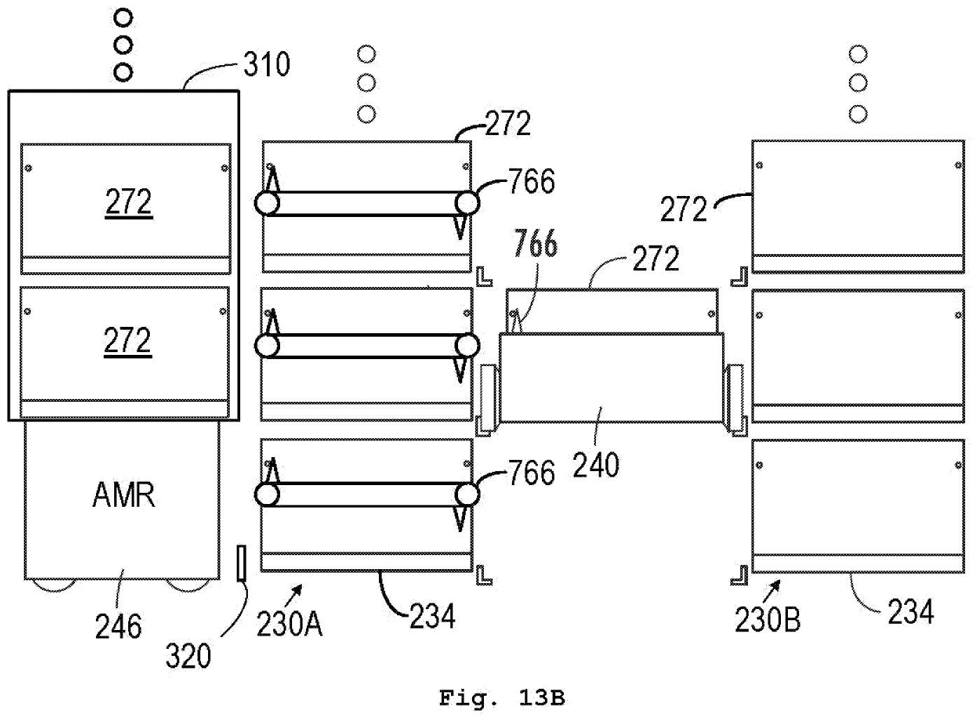

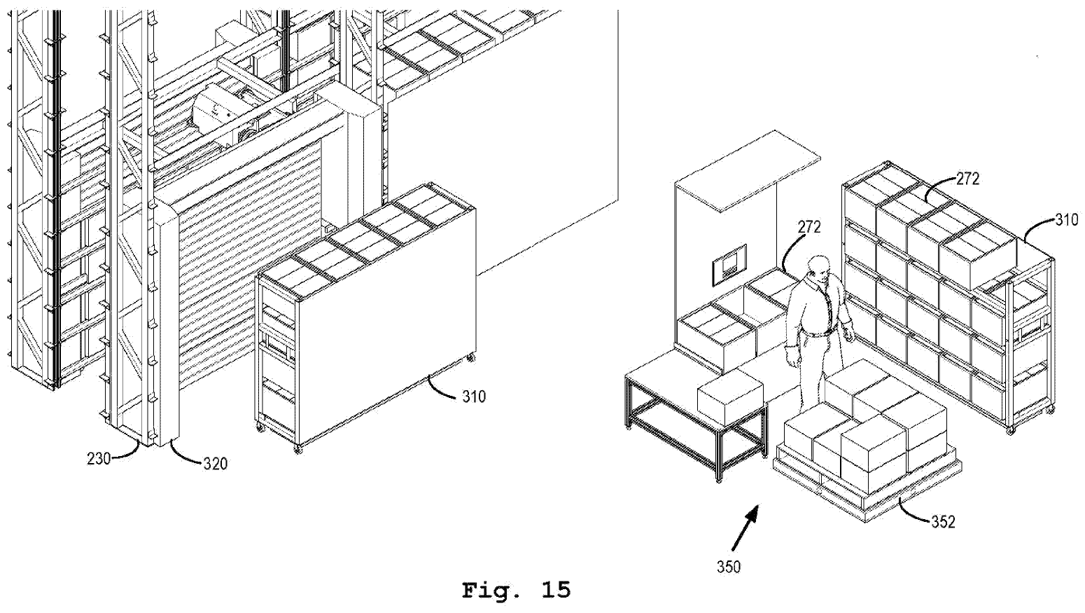

FIGS. 12A and 12B show rack 310 at a docking station 320 (shown schematically in FIGS. 12A-13B). Once positioned at docking station 320, a bot 240 may exchange totes 272 between the rack 310 and storage locations 234 of storage structure 230. In particular, the rack 310 may be supported on AMR 246, and AMR 246 may move the rack 310 into docking position with docking station 320. FIG. 12A shows a tote 272A on bot 240 whereas FIG. 12B shows the tote 272A having been moved into the rack 310, with another tote 272B on the bot 240. Totes 272 may additionally or alternatively be moved from rack 310 to storage locations 234, or from one position in rack 310 to another position in rack 310. The bot 240 is provided with a shuttle or tote transfer mechanism 766, for example as disclosed in U.S. Patent Publication No. US 2017/0313514 published Nov. 2, 2017 which is incorporated by reference herein in its entirety. Here, the shuttle or tote transfer mechanism 766 on bot 240 may selectively place totes to AGV/PGV 756 for removal from ASRS 762 or pick totes from AGV/PGV 756 for induction into ASRS 762. FIGS. 15A and 15B show an example of a synchronous handoff between AGV/PGV 756 and bot 760 where timing and location of the two for transfer need to be synchronously handled.

Referring now to FIGS. 13A and 13B, there is shown an end view of a rack 310 at a docking station 320. Once positioned at docking station 320, a bot 240 may exchange totes 272 between the rack 310 and storage locations 234 of storage structure 230. In this embodiment, each storage location for storing totes 272 within rack 310 may include a transfer mechanism integrated into the storage location. The transfer mechanism may for example be a shuttle or tote transfer mechanism 766. Thus, once AMR 246 docks the rack 310 to the docking station 320, the transfer mechanisms within the rack 310 may transfer totes 272 from rack 310 to the array of storage locations 234 in storage structure 230A immediately adjacent to the storage rack 310, or the transfer mechanisms within rack 310 may transfer totes from the storage locations 234 in storage structure 230A into the rack 310. Storage locations including a transfer mechanism may be considered “active,” where storage locations not including a transfer mechanism may be considered “passive.” Thus, in the embodiment of FIG. 13A, the storage locations in rack 310 are active, the array of storage locations 234 in storage structure 230A are passive, the bot 240 is active, and the array of storage locations in storage structure 230B are passive. Using this structure, totes 272 may be moved between any of the rack 310, the storage locations 234 in storage structure 230A and the storage locations 234 in storage structure 230B. In the examples of FIGS. 13A and 13B, it is conceivable that a transfer mechanism be provided that transfers all totes 272 from rack 310 to the storage locations 234 in storage structure 230A at the same time, or vise-versa (from storage structure 230A to rack 310 at the same time). In the example of FIG. 13A, the transfer mechanism 766 on the bot is unable to reach storage locations within the rack 310. Thus, providing the storage locations within the rack 310 with active transfer mechanisms allows automated transfer to and from the rack 310.

FIG. 13B shows a similar embodiment to FIG. 13A, but in this embodiment, transfer mechanisms such as the shuttle or tote transfer mechanisms 766 may be omitted from the storage locations in rack 310, and are instead incorporated into the storage locations 234 of storage structure 230A. Thus, in the embodiment of FIG. 13B, the storage locations in rack 310 are passive, the array of storage locations 234 in storage structure 230A are active, the bot 240 is active, and the array of storage locations in storage structure 230B are passive. Using this structure, totes 272 may be moved between any of the rack 310, the storage locations 234 in storage structure 230A and the storage locations 234 in storage structure 230B. FIGS. 13A and 13B show examples of an asynchronous handoff between rack 310, storage locations 234 in storage structures 230A, 230B and bot 240, where timing and location of the rack 310 and storage structures 230A, 230B for transfer need not be synchronously handled. In the examples of FIGS. 13A and 13B, it is conceivable that a transfer mechanism be provided that transfers all totes 272 from rack 310 to the storage locations 234 in storage structure 230A at the same time, or vise-versa (from storage structure 230A to rack 310 at the same time). That transfer mechanism can be all shuttle or tote transfer mechanisms in the rack or storage structure 230A moving totes at the same time, or some other mass-transfer mechanism.

There may be a variety of applications for the rack 310 of the present technology. In one example, the rack 310 may be used in a “hub-and-spoke” distribution system, where an automated distribution center (the hub) may load racks 310 with totes for shipment out to a number of retails stores (the spokes) which may or may not have automation. Racks 310 may be sent to stores with automation, or other distribution centers having automation. In such examples, upon arrival at the automated store or facility, the racks may be assimilated into the storage system by docking at a docking station 320 as described above. Racks 310 travelling between automated facilities may include order or product totes (totes containing fulfilled orders, or inventory for fulfilling orders).

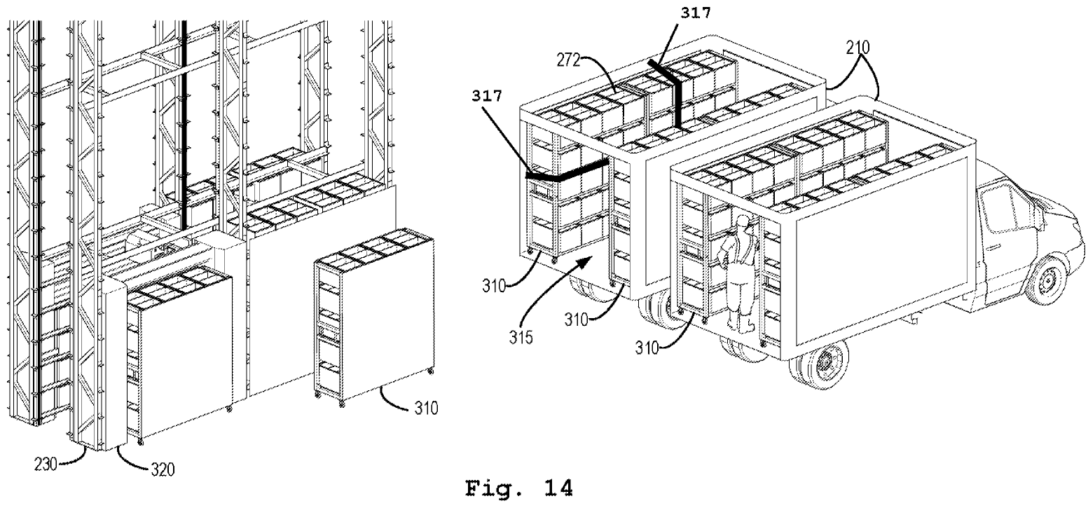

In a further example, racks may be loaded with orders at a distribution center for home delivery. In such an example, racks 310 may be loaded onto a truck 210 as shown in FIG. 14. Totes 272 with orders for home delivery may be loaded into racks 310 from the storage structure 230 while the racks 310 are at the docking station 320, for example according to any of the embodiments described above. Thereafter, the racks 310 may be brought to trucks 210 (either on casters or by AMRs 246) and loaded onto trucks 210. The racks may be loaded along the edges of trucks 210 to leave an aisle 315 within the trucks. Each of the racks may be secured to the truck for transport using straps 317 securing the rack to the floor and/or walls of the truck where straps 317 may be applied horizontally, vertically or otherwise. Alternately any suitable method of securing the racks to the truck may be used. Thus, upon arriving at a home location, a delivery person can walk within aisle 315 and retrieve one or more sub-totes or bags within the appropriate tote 272, and deliver the items to that home location. The orders within totes 272 may be intelligently loaded into the truck 210, taking into consideration a route the driver will take to make the home deliveries so that the driver can efficiently retrieve orders from totes 272 while make the home deliveries.

A further application of racks 310 are for use at stand-alone load or unload stations within an automated facility. For example, FIG. 15 shows an example of a rack 310 at a stand-alone decant station 350. Inventory may be received at decant station 350, for example on pallets 352. Thereafter, any packaging may be removed from the inventory, and the inventory transferred to totes 272 at station 350. The inventory may be unpackaged and transferred into the totes 272 manually or by automated processes. Thereafter, the totes 272 may be loaded into rack 310, and the totes 272 in rack 310 may be assimilated into the storage location 230 at docking station 320 according to embodiments described above. Stand-alone stations such as decant station 350 may be advantageous in that you can have multiple such stand-alone stations to load multiple racks 310 outside of the critical path and operation of the automated storage and retrieval system (i.e., bots 240 interacting with storage structure 230). The racks can also enable off-line bagging of totes that are loaded onto racks, permitting the induction of bagged totes to be performed asynchronously between the humans and bots.

In embodiments described above, the AMR 246 is used to transport racks 310 to trucks, which then depart for delivery of the racks. In further embodiments, the AMR 246 itself may depart the automated order facility and deliver racks 310, or individual totes 272, to retail stores, to customers' homes and/or to other locations.

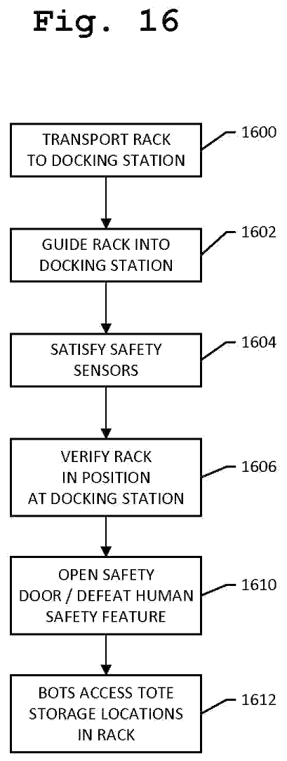

FIG. 16 is a flowchart for docking and undocking with safety features of FIGS. 3A-I. In step 1600, a rack 110 containing totes is transported to the docking station 236. The rack 110 may be manually guided into the docking station, or guided by an AMR 246 (1602). When the rack is inserted sufficient to satisfy the RFID safety sensors 256 (1604), the light curtain can be disabled to allow the rack to be fully inserted into the position where bots pick and place totes. In the event a human interrupts the light curtain without the rack in place in step 1604, an emergency-stop is activated to prevent the motion of all bots within the system or local to the docking module. In step 1606, the docking station 236 verifies that the rack is properly positioned at the docking station. Docking station 236 has side latches 264 and pins 266 where side latches 264 (both sides) need to be engaged by the rack 110. Once the rack properly engages the latches 264, the safety door 260 may open safely (1610). Thereafter, bots 240 traveling within bot support rails 238 may access tote storage locations within rack 110 (1612).

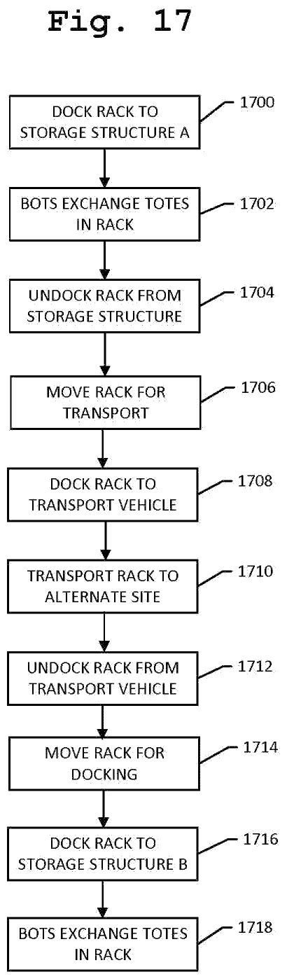

FIG. 17 is a flowchart for transporting site to site where each site has automation and storage. In step 1700, a rack 110 may be docked to a docking station 236 of a first storage structure 230 (storage structure A), and bots may transfer totes to and/or from rack 110 (1702). When tote transfer is complete, rack 110 may undock from docking station 236 either manually or automatedly positioned on an AMR 246 (1704), and the rack 110 may be manually or automatedly transported to a vehicle (1706) such as a truck 210 shown in FIGS. 2A-2C. The rack 110 may be docked to the vehicle in step 1708 by itself or along with one or more of the racks 110. The vehicle may include docking features that allow racks 110 to be secured within the vehicle. The one or more racks 110 are then transported by the vehicle to an alternate site (1710), whereupon the one or more racks 110 are undocked from the vehicle (1712) and transported away from the vehicle into the new site (1714). In step 1716, a rack 110 may be docked to a docking station 236 of a storage structure 230 at the new site (storage structure B), and bots may transfer totes to and/or from rack 110 at storage structure B (1718).

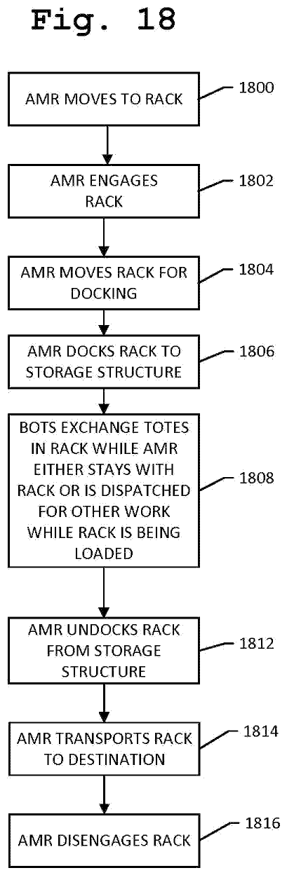

FIG. 18 is a flowchart for FIGS. 12A and 12B. In step 1800, an AMR 246 may move to a rack 310 (or the rack 310 may be moved to the AMR) and the AMR 246 may engage and support the rack 310 (1802). The AMR 246 then transports the rack 310 to a docking station 236 (1804), and the AMR 246 positions the rack 310 for docking at the docking station 236 and storage structure 230 (1806). Thereafter, bots 240 may exchange totes 272 between the rack 310 and storage locations 234 of storage structure 230 (1808). As noted above, a bot 240 may include a tote transfer mechanism 766 for transferring totes 272 between rack 310 and the storage locations 234. The AMR 246 may either stay at the rack 310 during step 1808, or the AMR may be dispatched for other work while the rack is being loaded. Once transfer of totes 272 to/from rack 310 is completed, the AMR 246 undocks the rack 310 from the storage structure 230 (1812) and the AMR 246 transports the rack 310 to a new destination (1814). The AMR 246 may they stay engaged, or the AMR 246 may disengage from the rack 310 upon arrival at the new destination (1816).

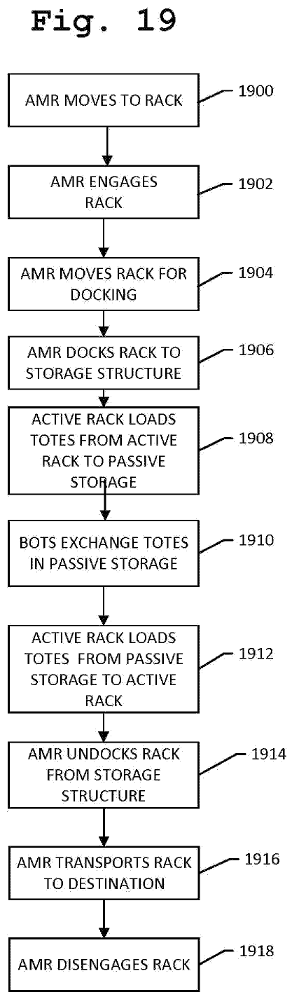

FIG. 19 is a flowchart for FIG. 13A. In step 1900, an AMR 246 may move to a rack 310 (or the rack 310 may be moved to the AMR) and the AMR 246 may engage and support the rack 310 (1902). The AMR 246 then transports the rack 310 to a docking station 236 (1904), and the AMR 246 positions the rack 310 for docking at the docking station 236 and storage structure 230 (1906). Thereafter, bots 240 may exchange totes 272 between the rack 310 and storage locations 234 of storage structure 230 (1908, 1910, 1912). As noted above, each storage location for storing totes 272 within rack 310 in the embodiment of FIG. 13A may include a transfer mechanism integrated into the storage location. Thus, in step 1908, the transfer mechanisms within the rack 310 may transfer totes 272 from rack 310 to the passive storage locations 234 in storage structure 230A, in step 1910, the transfer mechanisms within the rack 310 may transfer totes 272 between passive storage locations 234, or in step 1912, the transfer mechanisms within rack 310 may transfer totes from the storage locations 234 in storage structure 230A into the rack 310. The AMR 246 may either stay at the rack 310 during step 1908/1910/1912, or the AMR may be dispatched for other work while the rack is being loaded. Once transfer of totes 272 to/from rack 310 is completed, the AMR 246 undocks the rack 310 from the storage structure 230 (1914) and the AMR 246 transports the rack 310 to a new destination (1916). The AMR 246 may they stay engaged, or the AMR 246 may disengage from the rack 310 upon arrival at the new destination (1918).

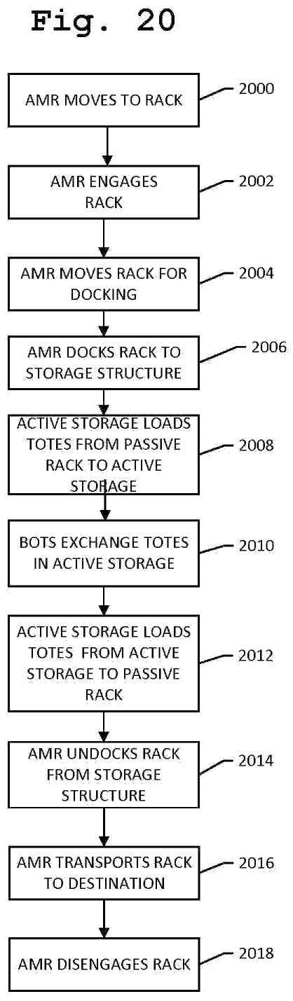

FIG. 20 is a flowchart for FIG. 13B. In step 2000, an AMR 246 may move to a rack 310 (or the rack 310 may be moved to the AMR) and the AMR 246 may engage and support the rack 310 (2002). The AMR 246 then transports the rack 310 to a docking station 236 (2004), and the AMR 246 positions the rack 310 for docking at the docking station 236 and storage structure 230 (2006). Thereafter, bots 240 may exchange totes 272 between the rack 310 and storage locations 234 of storage structure 230 (2008, 2010, 2012). As noted above, in the embodiment of FIG. 13B, the transfer mechanisms may be omitted from the storage locations in rack 310, and may instead be incorporated into the storage locations 234 of storage structure 230A. Thus, in step 2008, the transfer mechanisms within the storage structure 230A may transfer totes 272 from rack 310 to the active storage locations 234 in storage structure 230A, in step 2010, the transfer mechanisms within the storage structure 230A may transfer totes 272 around within the storage structure 230A and/or 230B, or in step 2012, the transfer mechanisms within storage structure 230A may transfer totes from the active storage locations 234 in storage structure 230A into the rack 310. The AMR 246 may either stay at the rack 310 during steps 2008/2010/2012, or the AMR may be dispatched for other work while the rack is being loaded. Once transfer of totes 272 to/from rack 310 is completed, the AMR 246 undocks the rack 310 from the storage structure 230 (2014) and the AMR 246 transports the rack 310 to a new destination (2016). The AMR 246 may they stay engaged, or the AMR 246 may disengage from the rack 310 upon arrival at the new destination (2018).

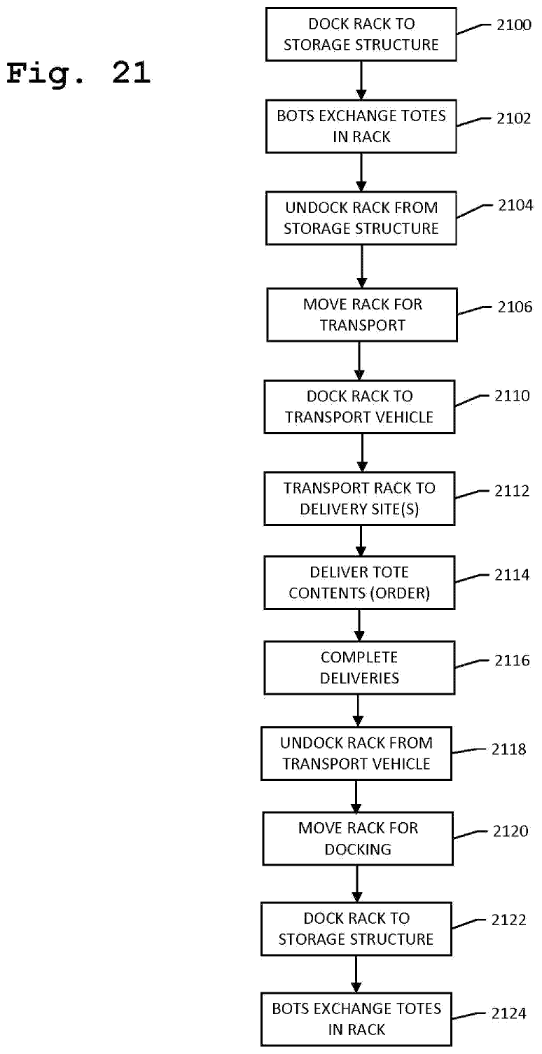

FIG. 21 is a flowchart for using the truck in FIG. 14 to deliver grocery orders to customers. In step 2100, a rack 110 may be docked to a docking station 236 of a storage structure 230, and bots may transfer totes to and/or from rack 110 (2102). When tote transfer is complete, rack 110 may undock from docking station 236 either manually or automatedly positioned on an AMR 246 (2104), and the rack 110 may be manually or automatedly transported to a vehicle (2106) such as a truck 210 shown in FIG. 14. The rack 110 may be docked to the vehicle in step 2110 by itself or along with one or more of the racks 110. The vehicle may include docking features that allow racks 110 to be secured within the vehicle. The one or more racks 110 are then transported (2112) by the vehicle to a delivery site(s) such as one or more homes, whereupon the one or more racks 110 are undocked from the vehicle and delivered to the site(s) (2114). Once deliveries are completed (2116), the truck may return to the order fulfillment facility and undock from the transport vehicle (2118). Once at the facility, a rack 110 may be transported (2120) to a docking station 236 and docked (2122). Thereafter, bots may transfer totes to and/or from rack 110 at the storage structure (2124).

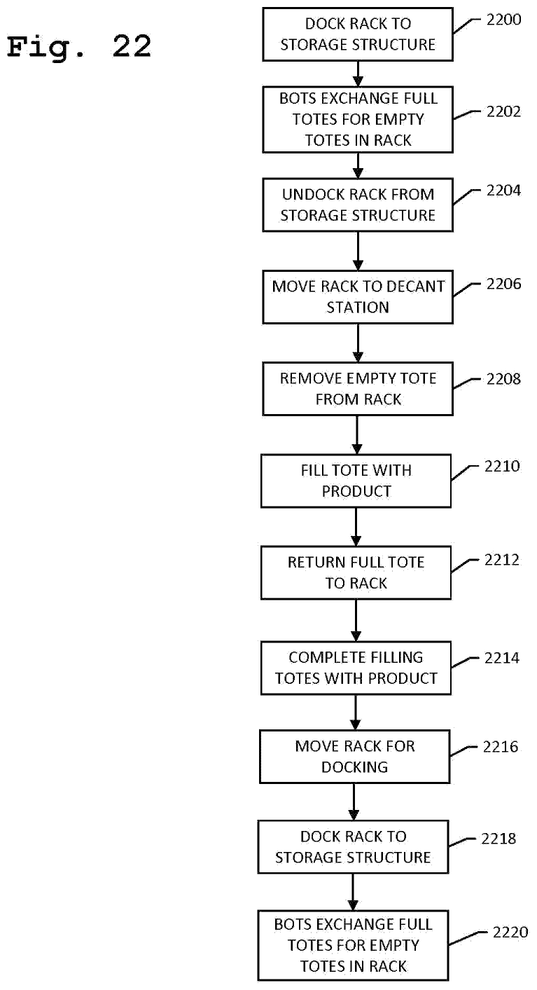

FIG. 22 is a flowchart for decant like FIG. 15. In step 2200, a rack 110 may be docked to a docking station 236 of a storage structure 230, and bots may exchange full totes for empty totes within the rack 110 (2202). When tote transfer is complete, rack 110 may undock from docking station 236 either manually or automatedly positioned on an AMR 246 (2204), and the rack 110 may be manually or automatedly transported to a decant station (2206) such as a decant station 350 shown in FIG. 15. Empty totes may be removed from the rack 110 (2208), the empty totes may be filled with product inventory (2210), and the filled totes may be returned to the rack 110 (2212). Once the rack 110 is again filled with full totes (2214), the rack 110 may be manually or automatedly transported away from the decant station 350 (2216) to dock to a docking station 236 of a storage structure 230 (2218). Thereafter, bots may again exchange full totes for empty totes within the rack 110 (2220).

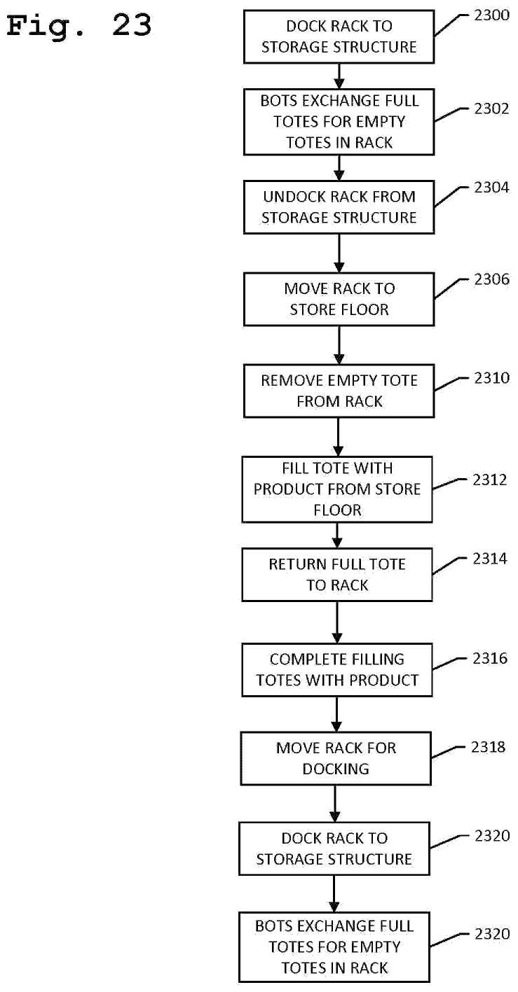

FIG. 23 is a flowchart for replenishing the automation using a rack and pulling inventory from the store floor. In step 2300, a rack 110 may be docked to a docking station 236 of a storage structure 230, and bots may exchange full totes for empty totes in the rack 110 (2302). When tote transfer is complete, rack 110 may undock from docking station 236 either manually or automatedly positioned on an AMR 246 (2304), and the rack 110 may be manually or automatedly transported to the store floor (2306). There, empty totes may be removed from the rack 110 (2310), filled with product from the store floor (2312), and returned to the rack 110 (2314). Once the rack 110 is again filled with full totes (2316), the rack 110 may be manually or automatedly transported from the store floor (2318) to dock to a docking station 236 of a storage structure 230 (2320). Thereafter, bots may again exchange full totes for empty totes within the rack 110 (2320).

The rack 110 may be docked to the vehicle in step 1708 by itself or along with one or more of the racks 110. The vehicle may include docking features that allow racks 110 to be secured within the vehicle. The one or more racks 110 are then transported by the vehicle to an alternate site (1710), whereupon the one or more racks 110 are undocked from the vehicle (1712) and transported away from the vehicle into the new site (1714). In step 1716, a rack 110 may be docked to a docking station 236 of a storage structure 230 at the new site (storage structure B), and bots may transfer totes to and/or from rack 110 at storage structure B (1718).

The foregoing detailed description has been presented for purposes of illustration and description. It is not intended to be exhaustive or to limit the description to the precise form disclosed. Many modifications and variations are possible in light of the above teaching. The described embodiments were chosen in order to best explain the principles of the claimed system and its practical application to thereby enable others skilled in the art to best utilize the claimed system in various embodiments and with various modifications as are suited to the particular use contemplated.

What is claimed is:

1. A docking station for docking a rack for transfer of containers to and from the rack by an autonomous mobile robot in a storage area, the docking station comprising:
a port into which the rack may be received for transfer of containers to and from the rack;
an engagement mechanism configured to move the rack into a secured position in the port;
sensors for sensing when the rack is secured in the port; and
a barrier configured to cover the port in the absence of a rack to separate the autonomous mobile robot in the storage area from an area adjacent the docking station where the rack travels, and to uncover the port when the rack is secured in the port to allow transfer of containers to and from the rack by the autonomous mobile robot.

2. The docking station of claim 1, wherein the barrier is a safety rated barrier.

3. The docking station of claim 1, wherein the barrier is a physical door.

4. The docking station of claim 3, wherein the engagement mechanism is further configured to move unseated totes back into seated position within the rack by pulling the rack against the barrier when the barrier is in a closed position.

5. The docking station of claim 1, wherein the barrier is a light curtain.

6. The docking station of claim 5, wherein movement of the autonomous mobile vehicle is disabled if the light curtain is interrupted where the sensors do not sense a rack secured in the port.

7. The docking station of claim 1, wherein the engagement mechanism comprise a pair of arms, one on each side of the port, for engaging within respective slots on opposed sides of the rack, the pair of arms rotating to pull the rack into the secured position in the port.

8. A system for transferring containers to and from a storage area to fulfill inventory orders in an automated storage and retrieval facility, the system comprising:
a rack configured to carry a plurality of containers and including engagement features configured to be engaged when securing the rack; and
a docking station for docking the rack for transfer of the plurality of containers to and from the rack by an autonomous mobile robot in a storage area, the docking station comprising:
a port into which the rack may be received for transfer of containers to and from the rack;
an engagement mechanism configured to engage the engagement feature of the rack to move the rack into a secured position in the port;
sensors for sensing when the rack is secured in the port; and
a barrier configured to cover the port in the absence of a rack to separate the autonomous mobile robot in the storage area from an area where rack is moved to and from the port, and to uncover the port when the rack is secured to allow transfer of containers to and from the rack by the autonomous mobile robot.

9. The system of claim 8, wherein the rack comprises an interlock feature for storing mechanical interface data used by the docking station to ensure proper securing of the rack in the docking station.

10. The system of claim 8, wherein the rack comprises an identification feature for storing data identifying at least one of the type of rack or type of containers transported by the rack.

11. The system of claim 8, wherein the storage area comprises first and second static storage locations separated by an aisle within which the mobile robot is configured to travel, the docking station positioned adjacent the aisle such that the mobile robot travelling in the aisle can transfer containers to and from the rack when the rack is secured in the docking station.

12. The system of claim 8, wherein the storage area comprises first and second static storage locations separated by an aisle within which the mobile robot is configured to travel, the docking station positioned adjacent a first storage location of the storage locations, on a side of the first storage location opposite the aisle.

13. The system of claim 12, wherein the rack further comprises a container transfer mechanism for transferring one or more containers between the rack and the first storage location.

14. The system of claim 12, wherein the first storage location further comprises a container transfer mechanism for transferring one or more containers between the rack and the first storage location.

15. The system of claim 8, further comprising one or more stand-alone stations separate from the storage area, the rack configured to travel between the docking station and the one or more stand-alone stations to transfer containers between the storage area and the one or more stand-alone stations.

16. The system of claim 15, wherein the one or more stand-alone stations comprise a stand-alone decant station, inventory arriving at the automated storage and retrieval facility being decanted into containers and the containers being placed in the rack for transfer from the stand-alone decant station to the storage area.

17. The system of claim 8, further comprising one of an autonomous mobile robot and casters for transporting the rack.

18. A system for fulfilling inventory orders using containers in an automated storage and retrieval facility, the system comprising:
a storage area comprising static storage locations for storing the containers;
a mobile robot configured to travel on rails adjacent the static storage locations to transfer containers to and from the static storage locations;
a rack comprising multiple levels configured to carry the containers, the rack being mobile and configured to move around the automated storage and retrieval facility; and
a docking station positioned at the storage area, the docking station configured to receive the rack and register the rack in a position adjacent the rails at the storage area enabling the mobile robot to transfer containers to and from the rack.

19. The system of claim 18, further comprising one or more stand-alone stations separate from the storage area, the rack configured to travel between the docking station and the one or more stand-alone stations to transfer containers between the storage area and the one or more stand-alone stations.

20. The system of claim 19, wherein the one or more stand-alone stations comprise a stand-alone decant station, inventory arriving at the automated storage and retrieval facility being decanted into containers and the containers being placed in the rack for transfer from the stand-alone decant station to the storage area.

21. The system of claim 18, wherein the docking station comprises sensors for sensing when the rack is secured in the docking station.

22. The system of claim 18, wherein the docking station comprises a barrier configured to cover a port in the docking station when no rack is positioned in the docking station, and to uncover the port when the rack is positioned at the docking station.

23. A system for fulfilling inventory orders using containers in an automated storage and retrieval facility, the system comprising:
a storage area comprising first and second static storage locations for storing the containers, the first and second static storage locations each comprising multiple levels for storing containers;
an aisle positioned between the first and second static storage locations;
a mobile robot configured to travel within the aisle to transfer containers to and from the first and second static storage locations;
a rack comprising multiple levels configured to carry the containers, the rack being mobile and configured to move around the automated storage and retrieval facility; and
a docking station positioned adjacent the first static storage location, on a side of the first static storage location opposite the aisle, the docking station configured to receive the rack and register the rack in a position adjacent the first static storage location.

24. The system of claim 23, wherein the rack further comprises a container transfer mechanism for transferring one or more containers between the rack and the first storage location.

25. The system of claim 23, wherein the first storage location further comprises a container transfer mechanism for transferring one or more containers between the rack and the first storage location.
